(19) United States
(12) Patent Application Publication
(10) Pub. No.: US 2024/0095939 A1
(43) Pub. Date: Mar. 21, 2024

(54) INFORMATION PROCESSING APPARATUS AND INFORMATION PROCESSING METHOD

(71) Applicant: Yuuki SUZUKI, Kanagawa (JP)

(72) Inventor: Yuuki SUZUKI, Kanagawa (JP)

(21) Appl. No.: 18/283,211

(22) PCT Filed: Mar. 16, 2022
(86) PCT No.: PCT/JP2022/011915

§ 371 Date: Sep. 21, 2023

(30) Foreign Application Priority Data
Mar. 23, 2021 (JP) 2021-048090
Mar. 23, 2021 (JP) 2021-048245

(51) Int. Cl. G06T 7/521; H04N 23/63; H04N 23/698

(52) U.S. Cl. CPC G06T 7/521; H04N 23/633; H04N 23/698

(57) ABSTRACT

An information processing apparatus includes a display control unit configured to display on a display unit a three-dimensional image that is determined based on an output of a light receiving unit that receives light projected on an object and reflected from the object, wherein the display control unit is configured to display, on the display unit, a display image including position identification information identifying a position of the light receiving unit obtained when the light receiving unit receives light reflected from the object, based on the position identification information identifying the position of the light receiving unit obtained when the light receiving unit receives light reflected from the object, and including the three-dimensional image.

### TECHNICAL FIELD

The present invention relates to an information processing apparatus and an information processing method.

### BACKGROUND ART

PTL 1 discloses a distance measuring apparatus capable of stably and accurately measuring a distance to an object.

PTL 2 discloses an image pickup apparatus that performs image processing to reduce an effect of reflection when a light reflection from a human's finger or the like occurs.

PTL 3 discloses a three-dimensional synthesis processing system that includes a measurement position display unit that extracts a block whose density of measurement data is lower than a predetermined threshold and outputs coordinates within a range of the extracted block as a measurement position at which a three-dimensional measurement apparatus should be set.

### SUMMARY OF INVENTION

### Technical Problem

An object of the present invention is to provide an information processing apparatus and an information processing method with which it is possible to easily compare a three-dimensional image with a corresponding situation at a place at which the three-dimensional image has been captured.

### Solution to Problem

The information processing apparatus according to the present invention includes a display control unit configured to display, on a display unit, a three-dimensional image that is determined based on an output of a light receiving unit that receives light projected on an object and reflected from the object. The display control unit is configured to display, on the display unit, a display image including position identification information identifying a position of the light receiving unit obtained when the light receiving unit receives light reflected from the object, based on the position identification information identifying the position of the light receiving unit obtained when the light receiving unit receives light reflected from the object, and the three-dimensional image.

### Advantageous Effects of Invention

According to the present invention, it is possible to provide an information processing apparatus and an information processing method with which it is possible to easily compare a three-dimensional image with a corresponding situation at a place at which the three-dimensional image has been captured.

Other objects, features and advantages of the present invention will become more apparent from the following detailed description when read in conjunction with the accompanying drawings.

### BRIEF DESCRIPTION OF DRAWINGS

FIG. 1 is a view depicting an example of an appearance of an image pickup apparatus according to an embodiment of the present invention.

FIG. 2 is a diagram illustrating a configuration of the image pickup apparatus according to the embodiment.

FIG. 3A is a view illustrating a state of use of the image pickup apparatus according to the embodiment.

FIG. 3B is a view illustrating a state of use of the image pickup apparatus according to the embodiment.

FIG. 3C is a view illustrating a state of use of the image pickup apparatus according to the embodiment.

FIG. 3D is a view illustrating a state of use of the image pickup apparatus according to the embodiment.

FIG. 4 is a diagram illustrating an example of a configuration of a processing block of a processing circuit according to the embodiment.

FIG. 5 is a flow diagram illustrating an example of an operation of the processing circuit of the image pickup apparatus according to the embodiment.

FIG. 6A is a flow diagram illustrating generation of omnidirectional image data according to the embodiment.

FIG. 6B is a flow diagram illustrating generation of omnidirectional image data according to the embodiment.

FIG. 7 is a flow diagram illustrating a determination with respect to an adjacent object according to the embodiment.

FIG. 8 is a view illustrating display contents of a display unit according to the embodiment.

FIG. 9 is a view illustrating an appearance of the image pickup apparatus according to a variant of the embodiment of the present invention.

FIG. 10 is a diagram illustrating a configuration of a processing block of a processing circuit according to the variant.

FIG. 11 is a view depicting an appearance of an image pickup apparatus according to a second variant of the embodiment of the present invention.

FIG. 12 is a diagram illustrating a configuration of a processing block of a processing circuit according to the second variant.

FIG. 13 is a flow diagram for a determination with respect to an adjacent object according to the second variant.

FIG. 14 is a view illustrating a configuration of an image pickup apparatus according to a third variant of the embodiment of the present invention.

FIG. 15 is a flow diagram for a determination with respect to a high reflective object according to the embodiment of the present invention.

FIG. 16 is a diagram illustrating a determination flow with respect to a distant object and a low reflective object according to the embodiment.

FIG. 17 is a flow diagram for a determination with respect to an image blur according to the embodiment.

FIG. 18A is a determination flow diagram according to a fourth variant of the embodiment of the present invention.

FIG. 18B is a determination flow diagram according to the fourth variant of the embodiment of the present invention.

FIG. 18C is a determination flow diagram according to the fourth variant of the embodiment of the present invention.

FIG. 19 is a diagram illustrating an example of a configuration of a processing block of a processing circuit according to a fifth variant of the embodiment of the present invention.

FIG. 20 is a diagram illustrating an example of a configuration of an information processing system according to a sixth variant of the embodiment of the present invention.

FIG. 21 illustrates an example of a configuration of an information processing system according to a seventh variant of the embodiment of the present invention.

FIG. 22 is a view illustrating display contents of the display unit according to the fifth to seventh variants.

FIG. 23A is a view illustrating a three-dimensional image displayed on the display unit according to the embodiment of the present invention.

FIG. 23B is a view illustrating a three-dimensional image displayed by the display unit according to the embodiment of the present invention.

FIG. 23C is a view illustrating a three-dimensional image displayed by the display unit according to the embodiment of the present invention.

FIG. 24 is a determination flow diagram according to the fifth to seventh variants.

FIG. 25 illustrates display contents of the display unit according to the fifth to seventh variants.

FIG. 26 is a flowchart illustrating processes according to the fifth to seventh variants.

FIG. 27 is a flow diagram illustrating processes according to the fifth to seventh variants.

### DESCRIPTION OF EMBODIMENTS

Hereinafter, embodiments of an image pickup apparatus and an image pickup processing method will be described in detail with reference to the accompanying drawings.

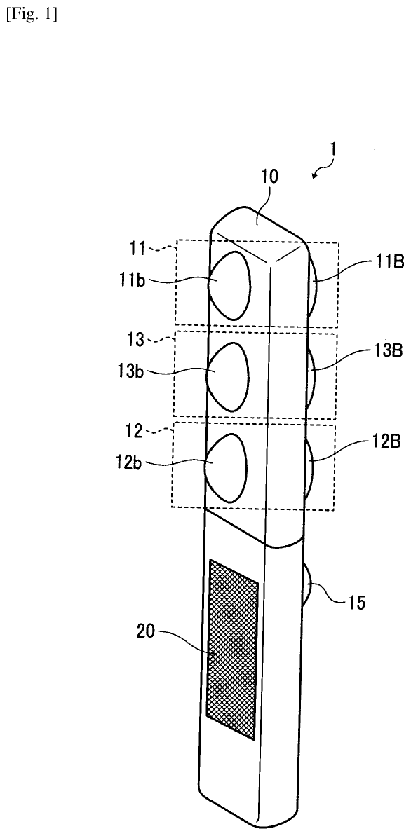

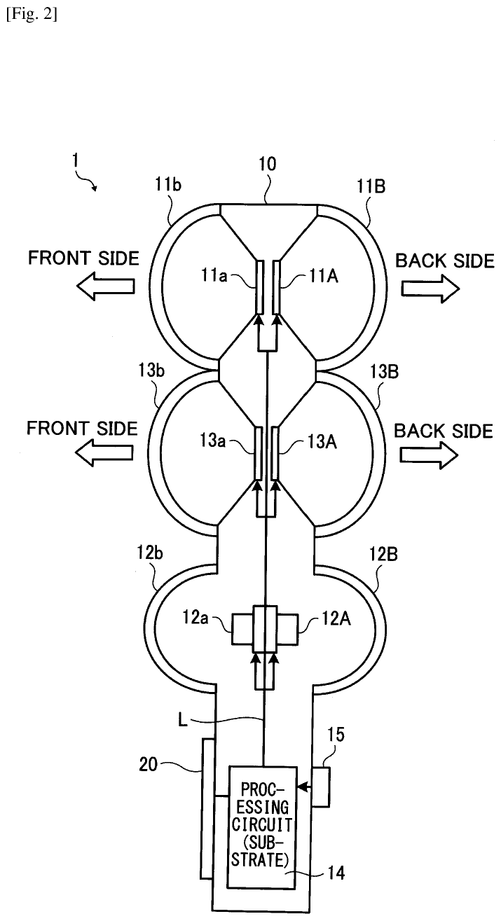

FIG. 1 is a diagram illustrating an example of an appearance of an image pickup apparatus according to an embodiment of the present invention. FIG. 2 is a diagram illustrating a configuration of the image pickup apparatus. FIG. 2 depicts the configuration inside the image pickup apparatus of FIG. 1.

The image pickup apparatus 1 is an example of an information processing apparatus that outputs three-dimensional information determined on the basis of received light. An image pickup unit (camera) 11, a projection unit (a part corresponding to a light emitting unit of a distance sensor) 12 that projects light other than visible light, and a range information obtaining unit (a part corresponding to a light receiving unit of the distance sensor) 13 that obtains range information based on the light projected by the projection unit 12 are contained in an integral manner in the housing 10. Each part is electrically connected to the processing circuit 14 inside the housing 10 by a synchronization signal line L, and operates in synchronization with the processing circuit 14.

An image pickup switch 15 is used by a user to input an image pickup instruction signal to the processing circuit 14. The display unit 20 displays contents corresponding to an output signal of the processing circuit 14 and is a liquid crystal display or the like. The display unit 20 is a touch panel or the like and may receive an operation input from a user. Based on the image pickup instruction, the processing circuit 14 controls each part and obtains data of an RGB image and range information, and reconstructs high-density three-dimensional point cloud data from the obtained range information data based on data of the RGB image and the range information.

Although it is possible to reconstruct three-dimensional point cloud data from range information data as it is, the accuracy of the three-dimensional point cloud data is limited by the number of pixels (resolution) of the range information obtaining unit 13 in this case. Hereinafter, processing using the three-dimensional point cloud data to re-construct high-density three-dimensional point cloud data will be described. The re-constructed data is output to an external personal computer (PC) through a portable recording medium or through communication, and is used to display a three-dimensionally restored model.

Various elements and the processing circuit 14 are supplied with power from a battery contained within the housing 10. Alternatively, the power may be supplied through a connection cable from the exterior of the housing 10.

The image pickup unit 11 captures two-dimensional image information and includes image pickup devices 11a and 11A, fish-eye lenses (wide-angle lenses) 11b and 11B, and the like. A projection unit 12 includes light source units 12a and 12A, wide angle lenses 12b and 12B, and the like. The range information obtaining unit 13 includes time of flight (TOF) sensors 13a and 13A, wide angle lenses 13b and 13B, and the like. Although not depicted, each unit may include an optical system such as a prism or lens group.

For example, an optical system for imaging light collected by the fish-eye lenses 11b and 11B with respect to the image pickup devices 11a and 11A may be included in the image pickup unit 11. In addition, an optical system may be included in the projection unit 12 to direct light from the light source units 12a and 12A to the wide angle lenses 12b and 12B. In addition, an optical system for imaging light collected by the wide-angle lenses 13b and 13B to the TOF sensors 13a and 13A may be included in the range information obtaining unit 13. Each optical system may be appropriately prepared in accordance with configurations and arrangements of the image pickup devices 11a and 11A, the light source units 12a and 12A, and the TOF sensors 13a and 13A. Hereinafter, description of such an optical system, such as a prism or lens group, if any, is omitted.

The image pickup devices 11a and 11A, the light source units 12a and 12A, and the TOF sensors 13a and 13A are integrally included in the housing 10. The fish-eye lens 11b, the wide-angle lens 12b, the wide-angle lens 13b, and the display unit 20 are provided on a first surface of the housing 10 at a front side. On the first surface, respective inner sides of the fish-eye lens 11b, wide-angle lens 12b, and wide-angle lens 13b have openings.

The fish-eye lens 11B, the wide-angle lens 12B, the wide-angle lens 13B, and the image pickup switch 15 are provided on a second surface at a back side of the housing 10. On the second surface, respective inner sides of the fish-eye lens 11B, wide-angle lens 12B, and wide-angle lens 13B have openings.

The image pickup devices 11a and 11A are image sensors (area sensors) with two-dimensional resolution. The image pickup devices 11a and 11A have image pickup areas in which a plurality of light receiving elements (photodiodes) as respective pixels are arranged in two-dimensional directions. The image pickup areas are provided with red (R), green (G), and blue (B) color filters, such as those of a Bayer array, for receiving visible light, and light passing through the color filters are stored in the photodiodes. According to the embodiment, image sensors each having a large number of pixels can be used to obtain a two-dimensional image of a wide angle (e.g., a range of a 180-degree celestial hemisphere with an image pickup direction facing the front as depicted in FIG. 2) at a high resolution.

The image pickup devices 11a and 11A transform light imaged in the image pickup areas into an electrical signal by a pixel circuit of each pixel to output high resolution RGB images. Each of the fish-eye lenses 11b and 11B collects light with respect to a wide angle (e.g., a range of a 180-degree celestial hemisphere with an image pickup direction facing the front as depicted in FIG. 2) and images the light into the image pickup area of the corresponding one of the image pickup devices 11a and 11A.

The light source units 12a and 12A are semiconductor lasers that emit laser light in a wavelength band (for example, infrared) other than the visible light region used for measuring a distance. One semiconductor laser may be used for each of the light source units 12a and 12A, or a plurality of semiconductor lasers may be used in combination. A surface emitting laser, such as a vertical cavity surface emitting laser (VCSEL), may be used as the semiconductor laser.

In addition, light of the semiconductor laser may be shaped by an optical lens so as to be lengthened vertically, and the light may be used for scanning in a one-dimensional direction of a measuring range using a light deflection element such as a micro electro mechanical systems (MEMS) mirror. In the present embodiment, the light source units 12a and 12A are configured to widen light of the semiconductor laser LA to a wide angle range through the wide angle lenses 12b and 12B without using light deflecting elements such as MEMS mirrors.

The wide-angle lenses 12b and 12B of the light source units 12a and 12A widen light emitted by the light source units 12a and 12A to wide-angle ranges (e.g., ranges of a 180-degree celestial hemisphere with an image pickup direction facing the front as depicted in FIG. 2).

The wide-angle lenses 13b and 13B of the range information obtaining unit 13 capture reflected light after light of the light source units 12a and 12A is projected by the projection unit 12 with respect to various directions for a wide angle having the measuring range (for example, a range of a 180-degree celestial hemisphere with an image pickup direction facing the front as depicted in FIG. 2) and image the light to light receiving areas of the TOF sensors 13a and 13A. The measuring range includes one or more projection targets (e.g., a building), and light (reflected light) reflected by the projection targets is incident at the wide angle lenses 13b and 13B. The reflected light may be captured, for example, through filters provided on the entire surfaces of the wide angle lenses 13b and 13B that cut light of wavelengths of the infrared region or a higher wavelength region. Note that embodiments of the present invention are not limited thereto, and, because what is needed is that light in the infrared region should be incident on the light receiving areas, devices for passing light in the infrared region such as filters in optical paths from the wide-angle lenses 13b and 13B to the light receiving areas may be provided.

The TOF sensors 13a and 13A are two-dimensional-resolution optical sensors. The TOF sensors 13a and 13A have light receiving areas in which a number of light receiving elements (photodiodes) are arranged in two-dimensional directions. The TOF sensors 13a and 13A may be referred to as “second image-pickup light receiving units”. The TOF sensors 13a and 13A receive reflected light from each area of the measuring range (each area may be referred to as a position) with the light receiving element corresponding to each area and measure (calculate) a distance to each area based on the light detected by each light receiving element.

According to the present embodiment, the distance is measured by a phase difference detection method. In the phase difference detection method, laser light on which amplitude modulation is performed with a fundamental frequency is used to irradiate the measurement range, the reflected light is received, the phase difference between the irradiated light and the reflected light is measured, and the time is obtained, and then, the distance is calculated by multiplying the time by the speed of light. The advantage of this method is that a necessary degree of resolution may be expected.

The TOF sensors 13a and 13A are driven in synchronization with illumination of light by the projection unit 12, and each light receiving element (corresponding to a pixel) calculates the distance corresponding to each pixel from the phase difference with respect to the reflected light, and outputs the range information image data (also referred to as a “range image” or a “TOF image”, later) in which information indicating the distance to each area within the measurement range is associated with the pixel information. The TOF sensors 13a and 13A may output phase information image data in which phase information is associated with the pixel information; range information image data may be then obtained based on the phase information image data in post-processing.

The number of areas in which the measurement range can be divided is determined by the resolution of the light receiving area. Accordingly, if the light receiving area has a low resolution for the purpose of miniaturization, the number of sets of pixel information of the range image data is reduced, so that the number of points included in each of the three-dimensional point clouds is reduced.

Alternatively, the distance may be measured by a pulse method instead of the phase difference detection method. In this case, for example, the light source units 12a and 12A emit irradiation pulses P1 of ultrashort pulses with rise times of few nanoseconds (ns) and high peak power, and, while being synchronized with the light source units 12a and 12A, the TOF sensors 13a and 13A measure the time (t) taken until the reflected pulses P2, which are the reflected light of the irradiation pulses P1 emitted by the light source units 12a and 12A, are received.

When this method is employed, for example, as the TOF sensors 13a and 13A, sensors on which circuits for measuring time on the output sides of the light receiving elements are mounted are used. In each circuit, the time required for the light source units 12a and 12A to emit the irradiation pulses P1 and receive the reflected pulses P2 is transformed into a distance for each light receiving element to obtain the distance to each area.

This method is suitable for widening the angle of the image pickup apparatus 1 because peak light can be used to output intense light. In addition, when a configuration in which light is deflected (performs scanning) using a MEMS mirror or the like is used, it is possible to emit intense light to a distance while suppressing widening of the light, thus increasing the measurement distance. In this case, such an arrangement is provided that laser light emitted from the light source units 12a and 12A performs scanning (is deflected) by a MEMS minor toward the wide-angle lenses 12b and 12B.

It is preferable that the effective angle of view of the image pickup unit 11 and the effective angle of view of the range information obtaining unit 13 are equal to each other as, for example, being 180 degrees or more, but it is not necessary to make these angles to be equal to each other. If necessary, each of the effective angle of view of the image pickup unit 11 and the effective angle of view of the range information obtaining unit 13 may be reduced. According to the present embodiment, with respect to each of the image pickup unit 11 and the range information obtaining unit 13, the effective pixels are reduced in number to fall within a range of, for example, 100 degrees to 180 degrees so that the image pickup apparatus 1 body and the range information obtaining unit 13 are not included in the angle of view.

The resolutions of the TOF sensors 13a and 13A may be set to be lower than the resolutions of the image pickup devices 11a and 11A preferentially for achieving the miniaturization of the image pickup apparatus 1. As a result of the TOF sensors 13a and 13A thus having lower resolutions than the image pickup devices 11a and 11A, the sizes of the light receiving areas can be reduced, and thus the size of the image pickup apparatus 1 can be reduced. In this case, the TOF sensors 13a and 13A thus have low resolutions, and the three-dimensional point clouds obtained by the TOF sensors 13a and 13A have a low density. However, because the processing circuit 14 that is an “obtaining unit” is provided, it is possible to transform the point clouds to high-density three-dimensional point clouds. The processing of transforming the point clouds by the processing circuit 14 to high-density three-dimensional point clouds will be described later.

In the present embodiment, for example, the image pickup device 11a, the light source unit 12a, and the TOF sensor 13a are arranged in a straight line along the longitudinal direction of the housing 10. Similarly, the image pickup device 11A, the light source unit 12A, and the TOF sensor 13A are arranged in a straight line along the longitudinal direction of the housing 10. Hereinafter, description will be made using the image pickup device 11a, the light source unit 12a, and the TOF sensor 13a will be described as an example.

The image pickup area (image pickup surface) of the image pickup device 11a or the light receiving area (light receiving surface) of the TOF sensor 13a may be set in a direction perpendicular to the longitudinal direction as depicted in FIG. 2, or may be set in the longitudinal direction with providing a prism or the like that changes the rectilinear propagation direction (optical path) of light by 90 degrees before the light is incident on the image pickup area or the light receiving area. Alternatively, the orientations of these sensors may be set depending on the configurations. That is, the image pickup device 11a, the light source unit 12a, and the TOF sensor 13a are set with respect to the same measurement range. The image pickup unit 11, the projection unit 12, and the range information obtaining unit 13 are set toward the measurement ranges at the corresponding sides of the housing 10.

In this regard, what is needed is that the image pickup device 11a and the TOF sensor 13a can be set to have the same baseline to implement a parallel-stereo configuration. Even if the image pickup device 11a is only one image pickup device, the output of the TOF sensor 13a can be used to obtain parallax data, by setting the image pickup device 11a and the TOF sensor to implement a parallel-stereo configuration. The light source unit 12a is configured so as to irradiate the measuring range of the TOF sensor 13a with light.

(Processing Circuit)

Next, processing of the processing circuit 14 will be described. TOF images obtained by only the TOF sensors 13a and 13A have low resolutions. Accordingly, with regard to the present embodiment, an example in which a high resolution is achieved by the processing circuit 14, and high-density three-dimensional point cloud data is reconstructed, is depicted. Some or all of the following processes performed by the processing circuit 14 as an “information processing unit” may be performed by an external apparatus instead.

As described above, three-dimensional point cloud data reconstructed by the image pickup apparatus 1 is output to an external apparatus such as a PC through a portable recording medium or through communication, and is used to display a three-dimensionally restored model.

Accordingly, compared to a case where an image pickup apparatus 1 itself displays a three-dimensionally restored model, it is possible to provide the image pickup apparatus 1 with excellent portability by increasing the speed, reducing the size, and reducing the weight.

However, after three-dimensional information is reconstructed by an external apparatus away from a place where three-dimensional information is obtained, it may be found that the taken image unintentionally contains the person who takes the image himself/herself or a tripod, or that the obtained three-dimensional information does not have a desired layout. In such a case, it takes time to visit the place where the three-dimensional information has been captured again.

To solve this problem, it is conceivable to bring an external apparatus such as a PC to the place, but in such a case, the advantages of higher speed, smaller size, and lighter weight may be eliminated.

In addition, it is possible to transmit the captured three-dimensional information to the external apparatus through a communication line and receive the reconstructed three-dimensional information from the external apparatus. However, the advantage of higher speed is eliminated, and also, it is difficult to visually determine whether the taken image contains the person who takes the image himself or herself or the tripod, because the amount of the three-dimensional information is large.

Especially in a case of omnidirectional three-dimensional information, it is extremely difficult to visually determine whether the person who takes the image himself or herself, or his/her tripod appears in the taken image.

In view of the foregoing problems, an object of the present embodiment is to provide an image pickup apparatus 1 with which it is easy to determine in real time that the person who takes the image himself/herself, a tripod, or the like appears in the taken image or that the obtained three-dimensional information does not have the desired layout.

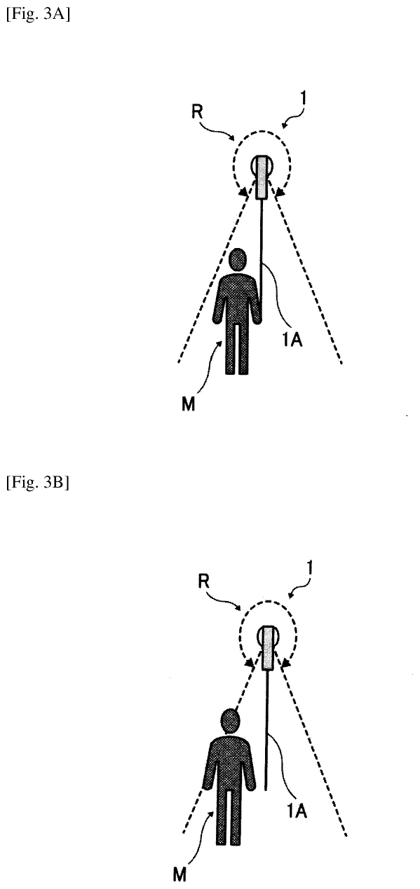

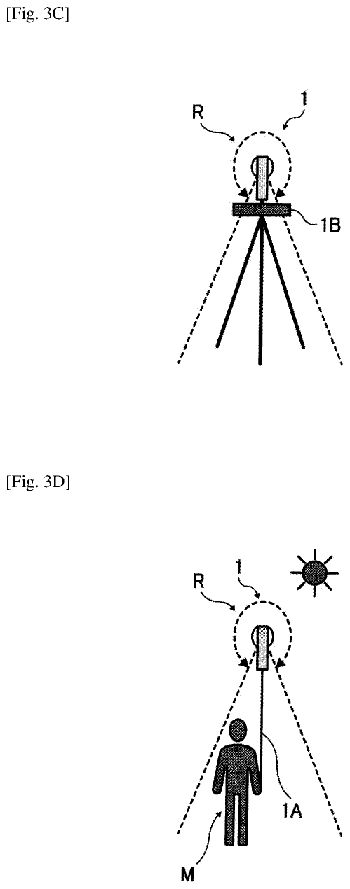

FIGS. 3A-3D are diagrams illustrating states of use of the image pickup apparatus according to the embodiment.

In a state depicted in FIG. 3A, the person who takes the image M and a selfie stick 1A supporting the image pickup apparatus 1 are not included in the omnidirectional image pickup range R, and the person who takes the image M and the selfie stick 1A do not appear in the taken omnidirectional image.

In the state depicted in FIG. 3B, the person who takes the image M is included in the omnidirectional image pickup range R, and the person who takes the image M appears in the taken omnidirectional image.

In the state depicted in FIG. 3C, a tripod 1B supporting the image pickup apparatus 1 is included in the omnidirectional image pickup range R, and the tripod 1B appears in the omnidirectional pickup image.

In the state depicted in FIG. 3D, although the person who takes the image M and a selfie stick 1A supporting the image pickup apparatus 1 are not included in the omnidirectional image pickup range R and the person who takes the image M and the selfie stick 1A do not appear in the omnidirectional image, external light (e.g., sunlight, illumination, etc.) is strong, and therefore, a misunderstanding that something unintentionally appears in the omnidirectional image may occur.

In the states depicted in FIGS. 3B and 3C, it is difficult to equally determine whether an object appears in the taken image because the color, type, and appearance of the object are diverse depending on the specific object.

In the above-described states of FIGS. 3A-3D, it is difficult to determine presence of a specific object (adjacent object) such as a person who takes the image or a tripod based on range information image data output from the TOF sensors 13a and 13A, because it is difficult to determine whether a specific object is actually present or external light is too intense.

That is, when the charge stored amount with respect to a specific pixel of the TOF sensors 13a and 13A is saturated, it is difficult to determine only from the output of the TOF sensors 13a and 13A whether a specific object is present or external light intensity is too strong.

In view of the foregoing problems, another object of the present embodiment is to provide an image pickup apparatus 1 which is capable of accurately determining whether a specific object, such as the person who takes the image himself/herself or a tripod, appears in the taken image, by distinguishing from an influence of external light. The present embodiment also has an object to determine whether, not only an adjacent object but also an object such as a high-reflective object, a distant object, a low reflective object, or an image blur appears in the taken image.

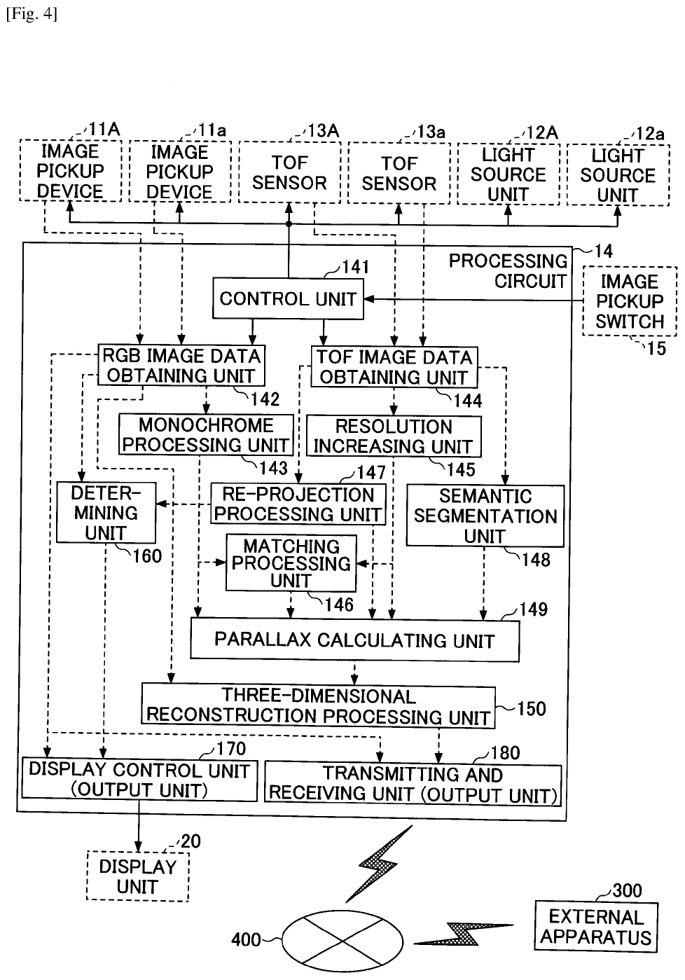

FIG. 4 is a diagram illustrating an example of a configuration of a processing block of the processing circuit 14. The processing circuit 14 depicted in FIG. 4 includes a control unit 141, a RGB image data obtaining unit 142, a monochrome processing unit 143, a TOF image data obtaining unit 144, a resolution increasing unit 145, a matching processing unit 146, a reprojection processing unit 147, a semantic segmentation unit 148, a parallax calculating unit 149, a three-dimensional reconstruction processing unit 150, a determining unit 160, a display control unit 170 as an example of an output unit, and a transmitting and receiving unit 180 as an example of an output unit. In FIG. 4, a solid arrow indicates a signal flow, and a broken arrow indicates a data flow.

When receiving a turning-on signal (image pickup start signal) from the image pickup switch 15, the control unit 141 outputs a synchronization signal to the image pickup devices 11a and 11A, the light source units 12a and 12A, and the TOF sensors 13a and 13A, and controls the entire processing circuit 14. The control unit 141 first outputs an instruction signal for emitting ultra-short pulses to the light source units 12a and 12A, and outputs an instruction signal for generating TOF image data to the TOF sensors 13a and 13A at the same time. The control unit 141 outputs an instruction signal for image pickup to the image pickup devices 11a and 11A. It should be noted that image pickup by the image pickup devices 11a and 11A may be performed during a period when the light source units 12a and 12A are emitting light or during a period immediately before or after the light source units 12a and 12A are emitting light.

The RGB image data obtaining unit 142 obtains RGB image data captured by the image pickup devices 11a and 11A and outputs omnidirectional RGB image data based on an image capturing instruction from the control unit 141. The monochrome processing unit 143 performs a process of obtaining a corresponding data type for matching processing with the TOF image data obtained from the TOF sensors 13a and 13A. In the present embodiment, the monochrome processing unit 143 performs a process of transforming omnidirectional RGB image data into omnidirectional monochrome image data.

The TOF image data obtaining unit 144 obtains the TOF image data generated by the TOF sensors 13a and 13A based on an instruction signal for generating TOF image data from the control unit 141 and outputs omnidirectional TOF image data.

The resolution increasing unit 145 regards the omnidirectional TOF image data as monochrome image data and increases the resolution of the image data. Specifically, the resolution increasing unit 145 replaces the distance value corresponding to each pixel of the omnidirectional TOF image data with a value of the omnidirectional monochrome image data (i.e., a gray scale value). The resolution increasing unit 145 then increases the resolution of the omnidirectional monochrome image data up to the resolution of the omnidirectional RGB image data obtained from the image pickup devices 11a and 11A. Increasing the resolution, i.e., transforming to higher resolution data, is implemented, for example, by performing a common up-conversion process. As another method of increasing the resolution, for example, multiple frames of omni-directional TOF image data consecutively generated may be obtained and used to perform a super-resolution process of inserting distance data between adjacent points.

The matching processing unit 146 extracts feature amounts with respect to portions having textures with respect to the omnidirectional monochrome data obtained from increasing the resolution of the omnidirectional TOF image data and the omnidirectional monochrome image data obtained from the omnidirectional RGB image data, and performs matching processing based on the extracted feature amounts. For example, the matching processing unit 146 extracts edges from each monochrome image and performs matching processing between the extracted sets of edge information. Alternatively, the matching processing may be implemented using a manner of scale-invariant feature transform (SIFT) or the like where texture changes are expressed as feature amounts. Note that the matching processing is processing of searching for corresponding pixels.

A specific method of matching processing is, for example, block matching. Block matching is a method of calculating similarity between pixel values with respect to an extracted block of M-by-M (M is a positive integer0pixel size around a reference pixel and pixel values with respect to an extracted block of M-by-M-pixel size around a pixel that is the center of each search in the other image, and regarding the central pixel that has the highest degree of similarity as the corresponding pixel.

Similarity is calculated in different ways. For example, a formula expressing normalized cross-correlation (NCC) coefficient may be used. The NCC coefficient is such that the higher the value, the higher the similarity, and is 1 if the pixel values of the blocks are completely the same as each other.

In addition, matching processing may include weighting on a per area basis, because distance data with respect to a texture-less area may be included in omnidirectional TOF image data. For example, in calculation using the formula expressing a NCC coefficient, weighting may be performed on a non-edge portion (texture-less area).

Alternatively, instead of using the formula expressing a NCC coefficient, a selective correlation coefficient (SCC) or the like may be used.

The reprojection processing unit 147 performs a process of re-projecting omnidirectional TOF image data representing the distance of each position of the measurement range onto two-dimensional coordinates (a screen coordinate system) of the image pickup unit 11. To re-project is to identify the coordinates with respect to images of the image pickup devices 11a and 11A corresponding to three-dimensional points calculated by the TOF sensors 13a and 13A. The omnidirectional TOF image data depicts the positions of the three-dimensional points in the coordinate system centered on the range information obtaining unit 13 (mainly the wide angle lenses 13b and 13B). Thus, the three-dimensional points indicated by the omnidirectional TOF image data are re-projected onto the coordinate system centered on the image pickup unit 11 (mainly the fish-eye lenses 11b and 11B).

For example, the reprojection processing unit 147 performs translation of the coordinates of the three-dimensional points of the omnidirectional TOF image data to the coordinates of the three-dimensional points centered on the image pickup unit 11, and thereafter, performs a process of transforming the coordinates of the three-dimensional points of the omnidirectional TOF image data to the coordinates of the two-dimensional coordinate system (the screen coordinate system) of the omnidirectional RGB image data. Thus, the coordinates of the three-dimensional points of the omnidirectional TOF image data and the coordinates of the omnidirectional two-dimensional image information captured by the image pickup unit 11 are associated with each other. Thus, the reprojection processing unit 147 associates the coordinates of the three-dimensional points of the omnidirectional TOF image data with the coordinates of the omnidirectional two-dimensional image information captured by the image pickup unit 11.

The parallax calculating unit 149 calculates a parallax with respect to each position using a distance difference between the corresponding pixels obtained by matching processing. In a parallax matching process, surrounding pixels with respect to a position of re-projected coordinates are searched for using the re-projected coordinates obtained by the reprojection processing unit 147, so that the processing time can be shortened, or more detailed and high resolution range information can be obtained.

Segmentation data obtained by a semantic segmentation process by the semantic segmentation unit 148 may be used for the parallax matching process. In this case, more detailed and high resolution range information can be obtained.

In addition, the parallax matching process may be performed only on an edge or only on a portion having a large feature amount. For the other portions, for example, also with the use of the omnidirectional TOF image data, a propagation process may be performed using omnidirectional RGB image features, using a probabilistic method, or the like.

The semantic segmentation unit 148 uses a deep learning technique to provide a segmentation label indicating an object to an input image with respect to the measurement range. This further increases the reliability of calculation because each pixel of the omnidirectional TOF image data can be bound to any one of a plurality of distance areas classified on a per distance basis.

The three-dimensional reconstruction processing unit 150 obtains the omnidirectional RGB image data from the RGB image data obtaining unit 142, reconstructs the omni-directional three-dimensional data based on the range information output by the parallax calculating unit 149, and outputs high-density omnidirectional three-dimensional point clouds to which color information is added with respect to each three-dimensional point. The three-dimensional reconstruction processing unit 150 is an example of a three-dimensional information determining unit that determines three-dimensional information.

The determining unit 160 obtains the omnidirectional RGB image data from the RGB image data obtaining unit 142, obtains the omnidirectional TOF image data, from the reprojection processing unit 147, having been transformed to the data of the two-dimensional coordinate system of the omnidirectional RGB image data, determines based on the data whether a specific object appears in the taken image, and outputs a determination result to the display control unit 170.

The display control unit 170 obtains the omnidirectional RGB image data from the RGB image data obtaining unit 142, and displays the two-dimensional image information based on the obtained omnidirectional RGB image data on the display unit 20. The display control unit 170 displays a display image that includes information indicating the determination result obtained from the determining unit 160 and includes the two-dimensional image information on the display unit 20.

The display control unit 170 is an example of an output unit that outputs the two-dimensional image information captured by the image pickup unit 11 in addition to the three-dimensional information, and the display unit 20 is an example of a destination to which the two-dimensional image information is output.

The display control unit 170 may obtain the omnidirectional three-dimensional data from the three-dimensional reconstruction processing unit 150 and display the three-dimensional information on the display unit 20. In this case, specifically, the display control unit 170 may select a case in which the two-dimensional image information is displayed on the display unit 20 or a case in which the three-dimensional information is displayed on the display unit 20 depending on predetermined conditions. Thus, the display control unit 170 may output two-dimensional image information in addition to the three-dimensional information.

The transmitting and receiving unit 180 communicates with an external apparatus by wired or wireless technology and transmits (outputs) through the network 400 the omnidirectional three-dimensional data output from the three-dimensional reconstruction processing unit 150 and the omnidirectional two-dimensional image information output from the RGB image data obtaining unit 142 to the external apparatus 300 that performs a three-dimensional restoration process.

In the present embodiment, the two-dimensional image information captured by the image pickup unit 11 is “original two-dimensional image information” for generating “two-dimensional image data for display” or is “two-dimensional image data for display”. For example, there are a case where “two-dimensional image data for display” is generated from “original two-dimensional image information” in the image pickup apparatus 1, and a case where “original two-dimensional image information” is transmitted from the image pickup apparatus 1 to an external apparatus, and the external apparatus generates “two-dimensional image data for display” from the “original two-dimensional image information.”

The transmitting and receiving unit 180 is an example of an output unit that outputs three-dimensional information, and the external apparatus 300 is an example of an output destination to which three-dimensional information is output.

The transmitting and receiving unit 180 may transmit only omnidirectional three-dimensional data without transmitting omnidirectional two-dimensional image information. The transmitting and receiving unit 180 may include an interface circuit with respect to a portable storage medium such as an SD card, a personal computer, or the like.

### (Operation of Processing Circuit)

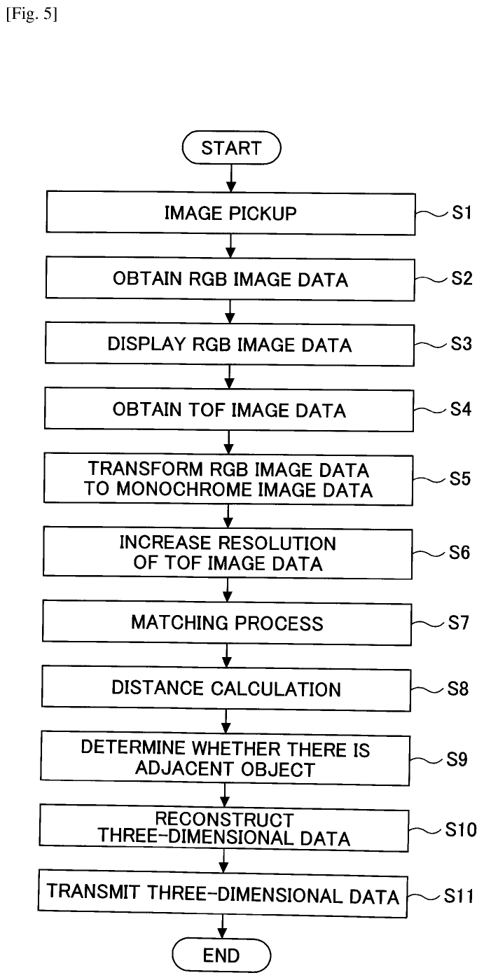

FIG. 5 is a flow diagram illustrating an example of an operation of the processing circuit 14 of the image pickup apparatus 1. The control unit 141 of the processing circuit 14 performs an operation to generate high-density three-dimensional point clouds by the following method (an example of an image pickup processing method and an information processing method) when the image pickup switch 15 is turned on by a user and an image pickup instruction signal is input.

First, in Step S1, the control unit 141 drives the light source units 12a and 12A, the TOF sensors 13a and 13A, and the image pickup devices 11a and 11A to capture an image of the measurement range. Driving by the control unit 141 causes the light source units 12a and 12A to emit infrared light (an example of a projection step), and the TOF sensors 13a and 13A receive the reflected light (an example of a light receiving step). In addition, the image pickup devices 11a and 11A capture an image of the measurement range at a timing of the start of the driving of the light source units 12a and 12A or during a period immediately before or after the start of the driving (an example of an image pickup step).

Next, in Step S2, the RGB image data obtaining unit 142 obtains the RGB image data of the measurement range from the image pickup devices 11a and 11A. In Step S3, the display control unit 170 obtains the omnidirectional RGB image data from the RGB image data obtaining unit 142 and displays the two-dimensional image information based on the obtained omnidirectional RGB image data on the display unit 20.

The display control unit 170 displays the two-dimensional image information of a portion of the obtained omnidirectional RGB image data on the display unit 20, and changes an area of the two-dimensional image information displayed on the display unit 20 according to any one of various inputs of the user. The various inputs of the user can be implemented through an operation switch other than the image pickup switch 15 or through the display unit 20 that is configured to be used as an input unit of a touch panel or the like.

At this stage, the person who takes the image can find that the two-dimensional image information displayed on the display unit 20 contains an image of the person who takes the image or a tripod, if any, or that the desired layout is not obtained.

Next, in Step S4, the TOF image data obtaining unit 144 obtains the TOF image data representing the distance from each position with respect to the two dimensional domain from the TOF sensors 13a and 13A.

Next, in Step S5, the monochrome processing unit 143 transforms the RGB image data into monochrome image data. The TOF image data and the RGB image data differ in the data types of the range data and the RGB data, respectively, and cannot be used for a matching process as they are. Therefore, each of the types of data is first transformed into monochrome image data. With regard to the TOF image data, the monochrome processing unit 143 transforms the value representing the distance of each pixel into the value of the monochrome image data before the resolution in-creasing unit 145 increases the resolution.

Next, in Step S6, the resolution increasing unit 145 increases the resolution of the TOF image data. Next, in Step S7, the matching processing unit 146 extracts a feature amount of a portion having a texture for each monochrome image and performs a matching process using the extracted feature amount.

Next, in Step S8, the parallax calculating unit 149 calculates the parallax of each position from the difference in the distance with respect to the corresponding pixel, and calculates the distance.

Next, the determining unit 160 obtains the omnidirectional RGB image data from the RGB image data obtaining unit 142, obtains from the reprojection processing unit 147 the omnidirectional TOF image data having been transformed into the data of the two-dimensional coordinate system of the RGB image data, determines whether an adjacent object appears in the taken image as a specific object based on these sets of data, and outputs the determination result to the display control unit 170 (an example of a determination step).

In Step S9, the display control unit 170 displays, on the display unit 20, information indicating the determination result obtained from the determining unit 160 by super-imposing the information indicating the determination result on the two-dimensional image information or causing the two-dimensional image information to include the information indicating the determination result (an example of a display step). In Step S9, the determining unit 160 determines whether there is a high-reflective object, a distant object, a low reflective object, an image blur, etc. as well as the adjacent object as a specific object and outputs the determination result to the display control unit 170. In Step S10, the three-dimensional reconstruction processing unit 150 obtains the RGB image data from the RGB image data obtaining unit 142, reconstructs the three-dimensional data based on the range information output by the parallax calculating unit 149, and outputs high density three-dimensional point clouds where color information is added to each three-dimensional point.

Next, in Step S11 (an example of the three-dimensional information output step), the transmitting and receiving unit 180 transmits through the network 400 the three-dimensional data output from the three-dimensional reconstruction processing unit 150 and the two-dimensional image information output from the RGB image data obtaining unit 142 to the external apparatus 300 that performs three-dimensional restoration processing.

The transmitting and receiving unit 180 may transmit the three-dimensional data output from the three-dimensional reconstruction processing unit 150 without transmitting the two-dimensional image information output from the RGB image data obtaining unit 142.

As described above, the image pickup apparatus 1 includes the image pickup unit 11 and the display control unit 170 that outputs the two-dimensional image information captured by the image pickup unit 11 in addition to the three-dimensional information.

Accordingly, it is possible for the person who takes the image to easily find from the two-dimensional image information that the person who takes the image himself/herself, a tripod, or the like appears in the taken image or that the desired layout is not obtained, using the two-dimensional information without using the three-dimensional information.

Accordingly, it becomes possible to obtain three-dimensional information again while being at the place where the three-dimensional information is captured. Thus, in comparison to a case where, after being away from the place where the three-dimensional information is obtained, the person who takes the image finds that the person who takes the image himself/herself, a tripod, or the like appears in the taken image, or that the desired three-dimensional information of the layout is not obtained in the taken image, there is no need to again visit the place where the three-dimensional information is obtained.

The three-dimensional information includes omnidirectional three-dimensional information. In this case, even though the omnidirectional three-dimensional information, from which it is difficult to find that the person who takes the image himself/herself, a tripod, or the like appears in the taken image or that the three-dimensional information of the desired layout is not obtained, is obtained, it is possible to easily find that the person who takes the image himself/herself, a tripod, or the like appears in the taken image or the three-dimensional information of the desired layout is not obtained from the two-dimensional image information captured by the image pickup unit 11.

The display control unit 170 outputs the two-dimensional image information G in Step S3 before the transmitting and receiving unit 180 transmits (outputs) the three-dimensional information in Step S11. The display control unit 170 outputs the two-dimensional image information G in Step S3 before the three-dimensional reconstruction processing unit 150 determines the three-dimensional information in Step S10.

As a result, it is possible to determine from the two-dimensional image information, before checking the three-dimensional information, that the person who takes the image himself/herself, a tripod, or the like appears in the taken image or that the desired layout is not obtained.

The display control unit 170 displays the two-dimensional image information on the display unit 20. The image pickup apparatus 1 includes the display unit 20.

Therefore, it is possible to easily find from the two-dimensional image information displayed on the display unit 20 that the person who takes the image himself/herself, a tripod, or the like appears in the taken image or that the desired layout is not obtained.

The display control unit 170 outputs the two-dimensional image information to the display unit 20 different from the external apparatus 300 to which the transmitting and receiving unit 180 outputs the three-dimensional information.

Accordingly, it is possible to find that the person who takes the image himself/herself, a tripod, or the like appears in the taken image or that the desired three-dimensional information of the layout is not obtained, from the two-dimensional image information output to the display unit 20 that is different from the external apparatus 300 without checking the three-dimensional information output to the external apparatus 300.

The image pickup apparatus 1 includes the three-dimensional reconstruction processing unit 150 that determines the three-dimensional information based on the output of the range information obtaining unit 13. The three-dimensional reconstruction processing unit 150 determines the three-dimensional information based on the output of the range information obtaining unit 13 and the two-dimensional image information.

Accordingly, it is possible to find from the two-dimensional image information captured by the image pickup unit 11 that the person who takes the image himself/herself, a tripod, or the like appears in the taken image, or that the desired layout is not obtained, without checking the three-dimensional information determined by the three-dimensional reconstruction processing unit 150.

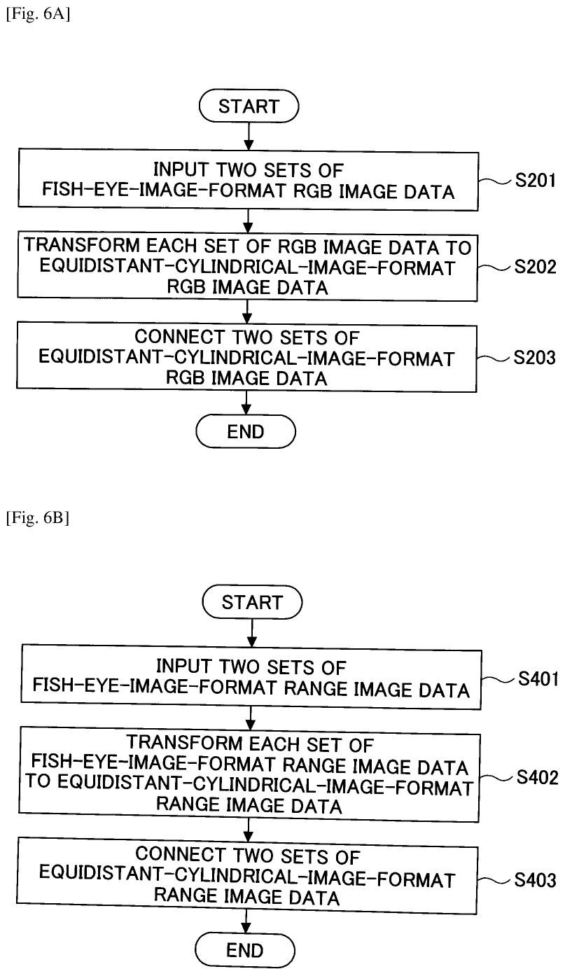

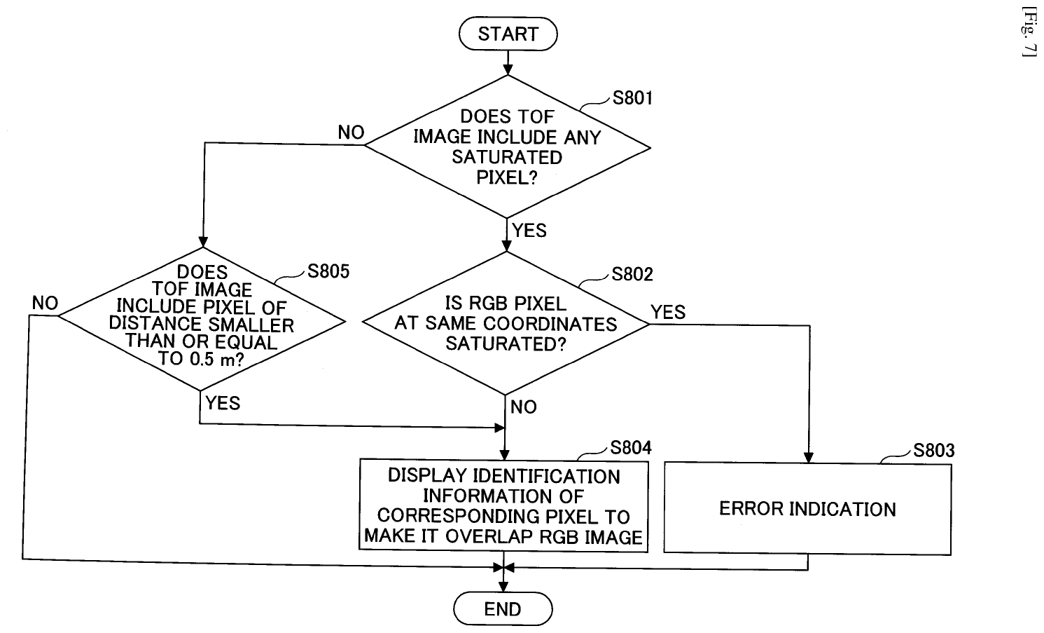

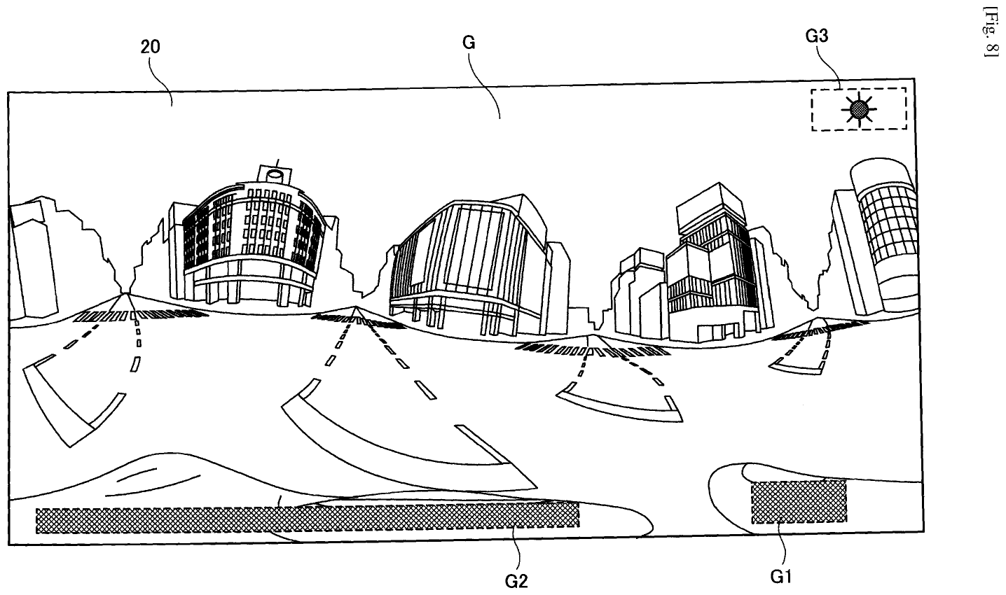

FIGS. 6A and 6B are flow diagrams for generation of omnidirectional image data according to the present embodiment.

FIG. 6A is a flowchart illustrating a process of generating the omnidirectional RGB image data corresponding to Step S2 described in FIG. 5.

In Step S201, the RGB image data obtaining unit 142 obtains two sets of RGB image data of a fish-eye image format.

In Step S202, the RGB image data obtaining unit 142 transforms each set of RGB image data to data of an equidistant cylindrical image format. The RGB image data obtaining unit 142 transforms two sets of RGB image data into data of the equidistant cylindrical image format based on the same coordinate system to facilitate image connection in the next step. The RGB image data can be transformed to image data using one or more image formats other than the equidistant cylindrical image format if necessary. For example, it is possible to transform the RGB image data to data having coordinates of an image obtained through perspective projection onto any plane or perspective projection onto each surface of any polyhedron.

The equidistant cylindrical image format will be now described. The equidistant cylindrical image format is an image format that is capable of expressing an omnidirectional image and is an image format of an equidistant cylindrical image generated through equidistant cylindrical projection. Equidistant cylindrical projection is a method of using two variables expressing three-dimensional directions, such as the latitude and longitude of a celestial globe, and providing a two-dimensional expression where the latitude and longitude are perpendicular to each other. Thus, an equidistant cylindrical image is an image generated through equidistant cylindrical projection, and is expressed by coordinates where two angular variables of a spherical coordinate system are used as two-axis variables.

In Step S203, the RGB image data obtaining unit 142 connects together the two sets of RGB image data generated in Step S202 and generates one set of omnidirectional RGB image data. The two sets of RGB image data that are used cover areas each having a total angle of view over 180 degrees. Therefore, the omnidirectional RGB image data generated by properly connecting together the two sets of RGB image data can cover the entire celestial area.

In addition, the connection process in Step S203 can use known technology for connecting together multiple images, and the method is not particularly limited.

FIG. 6B is a flowchart illustrating a process of generating the omnidirectional TOF image data corresponding to Step S4 described using FIG. 5.

In Step S401, the TOF image data obtaining unit 144 obtains two sets of range image data of a fish-eye image format.

In Step S402, the TOF image data obtaining unit 144 transforms the two sets of TOF image data of the fish eye image format to the data of the equidistant cylindrical image format. The equidistant cylindrical image format, as described above, is a system capable of expressing an omnidirectional image. In Step S402, the two sets of TOF image data are transformed to the data of the equidistant cylindrical image format based on the same coordinate system, thereby facilitating image connection in Step S403.

In Step S403, the TOF image data obtaining unit 144 connects together the two sets of TOF image data generated in Step S402 and generates one set of omnidirectional TOF image data. The two sets of TOF image data that have been used cover areas each having a total angle of view of over 180 degrees. For this reason, the omnidirectional TOF image data generated by properly connecting together the two sets of TOF image data can cover the entire celestial area.

In addition, the connection process in Step S403 can use known technology for connecting a plurality of images, and the method is not particularly limited.

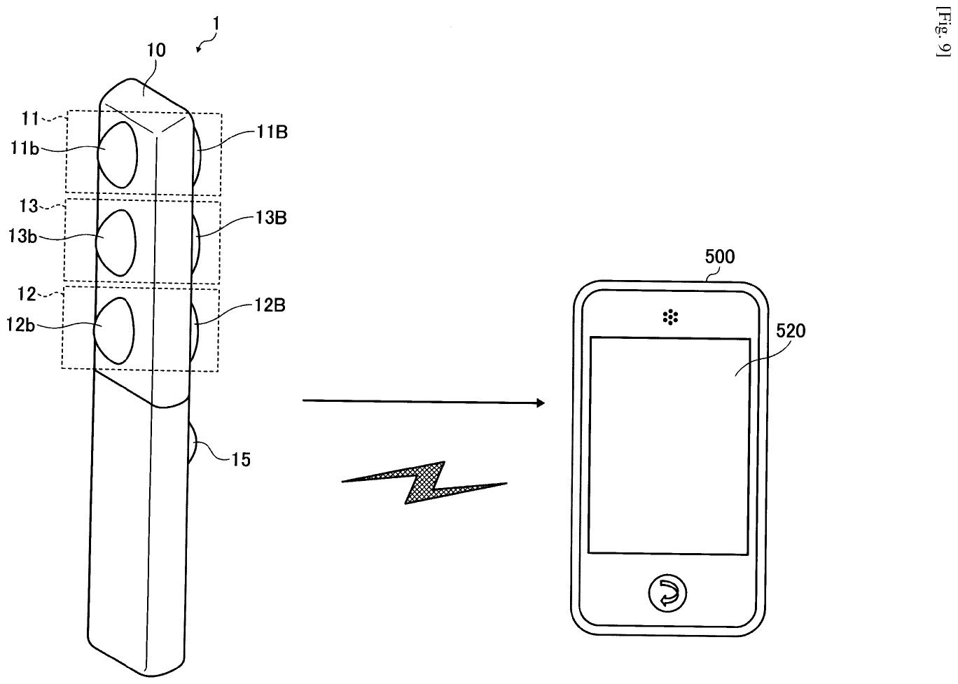

FIG. 7 is a flow diagram illustrating a process of identifying an adjacent object according to the present embodiment.

FIG. 7 is a flowchart illustrating a process of determining whether an adjacent object appears in the taken image, and corresponding to Step S9 described using FIG. 5.

In Step S801, the determining unit 160 determines based on the omnidirectional TOF image data obtained from the reprojection processing unit 147 whether there is a pixel for which the charge stored amount is saturated, as an example of a pixel for which the charge stored amount is more than or equal to a predetermined value, in the omnidirectional TOF image data.

In Step S802, when there is the pixel for which the charge stored amount is saturated

in Step S801, the determining unit 160 determines based on the omnidirectional RGB image data obtained from the RGB image data obtaining unit 142 whether, in the omnidirectional RGB image data, the charge stored amount is saturated, as an example in which the charge stored amount is more than or equal to a predetermined value, for the pixel having the same coordinates as the pixel for which the charge stored amount is saturated in Step S801.

When the charge stored amount is saturated in Step S802, the determining unit 160 determines that the charge stored amount is saturated in Step S801 due to external light (for example, sunlight or illumination) and outputs error information to the display control unit 170. In Step S803, the display control unit 170 displays a display image including the error information and two-dimensional image information on the display unit 20 based on the error information obtained from the determining unit 160.

When the charge stored amount is not saturated in Step S802, the determining unit 160 determines that the charge stored amount is saturated in Step S801 due to a presence of an adjacent object and outputs the coordinate position information of the pixel for which the charge stored amount is saturated in Step S801 to the display control unit 170. In Step S804, the display control unit 170 displays a display image including identification information for identifying the adjacent object based on the coordinate position information of the pixel obtained from the determining unit 160, and two-dimensional image information, on the display unit 20.

In Step S805, when there is no pixel for which the charge stored amount is saturated in Step S801, the determining unit 160 determines based on the omnidirectional TOF image data obtained from the reprojection processing unit 147 whether there is any pixel having the range information of 0.5 m or less in the omnidirectional TOF image data.

When there is no pixel having the range information of 0.5 m or less in Step S805, the determining unit 160 ends the process.

When there is a pixel having the range information of 0.5 m or less in Step S805, the determining unit 160 proceeds to Step S804 described above. It is determined in Step S804 that the pixel has the range information of 0.5 m or less in Step S805 due to a presence of an adjacent object, and outputs the coordinate position information of the pixel having the range information of 0.5 m or less in Step S805 to the display control unit 170. The display control unit 170 displays on the display unit 20 a display image including identification information for identifying the adjacent object based on the coordinate position information of the pixel obtained from the determining unit 160, and two-dimensional image information.

As described above, the display control unit 170 superimposes the identification information on the two-dimensional image information or causes the identification information to be included in the two-dimensional information when it is determined that the adjacent object is present, and does not superimpose identification information on the two-dimensional image information and does not cause identification information to be included in the two-dimensional information when it is determined that an adjacent object is not present.

That is, the display control unit 170 causes the display unit 20 to perform displaying differently depending on presence or absence of an adjacent object.

The display control unit 170 displays on the display unit 20 a display image including identification information for identifying the adjacent object on the basis of the coordinate position information of the pixel obtained from the determining unit 160, and including the two-dimensional image information.

That is, the display control unit 170 causes the display unit 20 to perform displaying differently at a position of the display unit 20 corresponding to the position of the adjacent object.

FIG. 8 is a diagram illustrating the display contents of the display unit according to the embodiment.

FIG. 8 is a diagram corresponding to Step S2 depicted in FIG. 5, and Steps S803 and S804 depicted in FIG. 7.

Two-dimensional image information G is displayed on the display unit 20 by the display control unit 170. The display unit 20 displays a display image including identification information G1 and G2 for identifying objects such as adjacent objects (e.g., a finger and a tripod), error information G3, and two-dimensional image information G by the display control unit 170. The error information G3 can be expressed using a mark such as a mark of a “sun or illumination” as depicted in FIG. 8.

As described above, the image pickup apparatus 1 includes the image pickup unit 11 for capturing an object, the projection unit 12 for projecting light to the object, the range information obtaining unit 13 for receiving light reflected by the object, and the display control unit 170 for causing the display unit 20 to perform displaying differently depending on presence or absence of an object, such as an adjacent object determined based on the output of the image pickup unit 11.

Thus, the person who takes the image can accurately find that the person who takes the image himself/herself or an adjacent object, such as a tripod, appears in the taken image, distinguishing the person who takes the image or an adjacent object from the effect of external light.

The image pickup apparatus 1 includes the display unit 20. This allows the person who takes the image to determine whether an adjacent object appears in the taken image.

The display control unit 170 causes the display unit 20 to perform displaying differently at a position of the display unit 20 corresponding to the position of an adjacent object. This allows the person who takes the image to identify the position of the adjacent object that appears in the taken image.

The display control unit 170 displays image information G captured by the image pickup unit 11 on the display unit 20 and displays a display image including identification information G1 and G2 for identifying adjacent objects and image information on the display unit 20. This ensures that the person who takes the image can identify the positions where the adjacent objects appear in the taken image.

The image pickup apparatus 1 includes the determining unit 160 that determines that an adjacent object is present when a charge stored amount for a pixel is saturated due to light received by the range information obtaining unit 13 as an example of the pixel for which the charge stored amount is more than or equal to a predetermined value, and also, a charge stored amount for the same pixel of the image pickup unit 11 is saturated as an example of the pixel for which the charge stored amount is not less than or equal to a predetermined value.

This allows the person who takes the image to accurately find that an adjacent object appears in the taken image, distinguishing the object from the effect of external light.

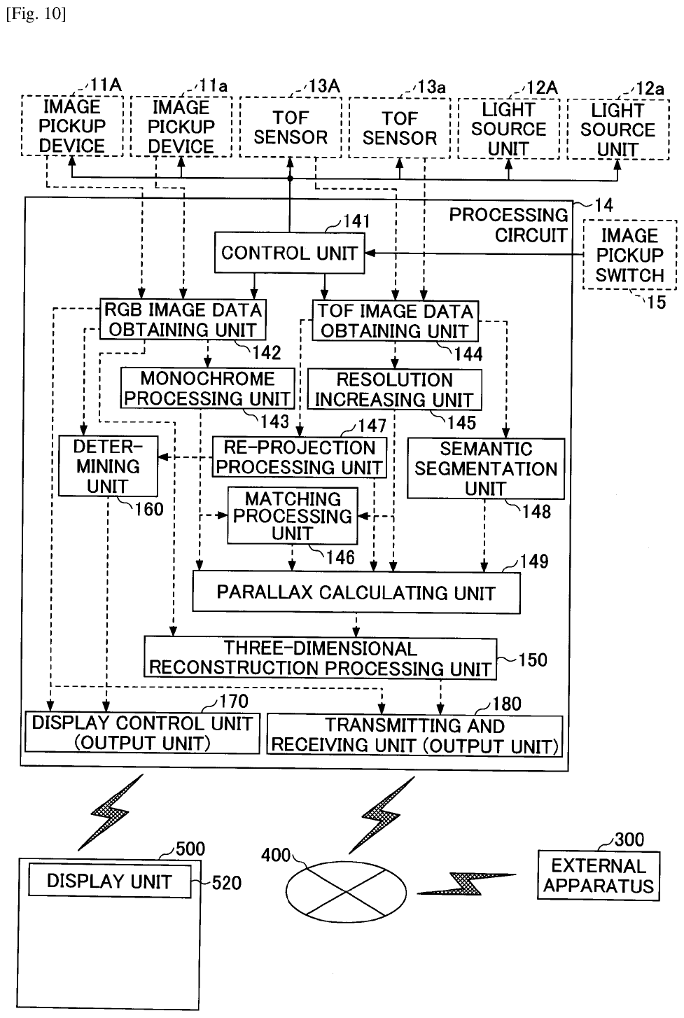

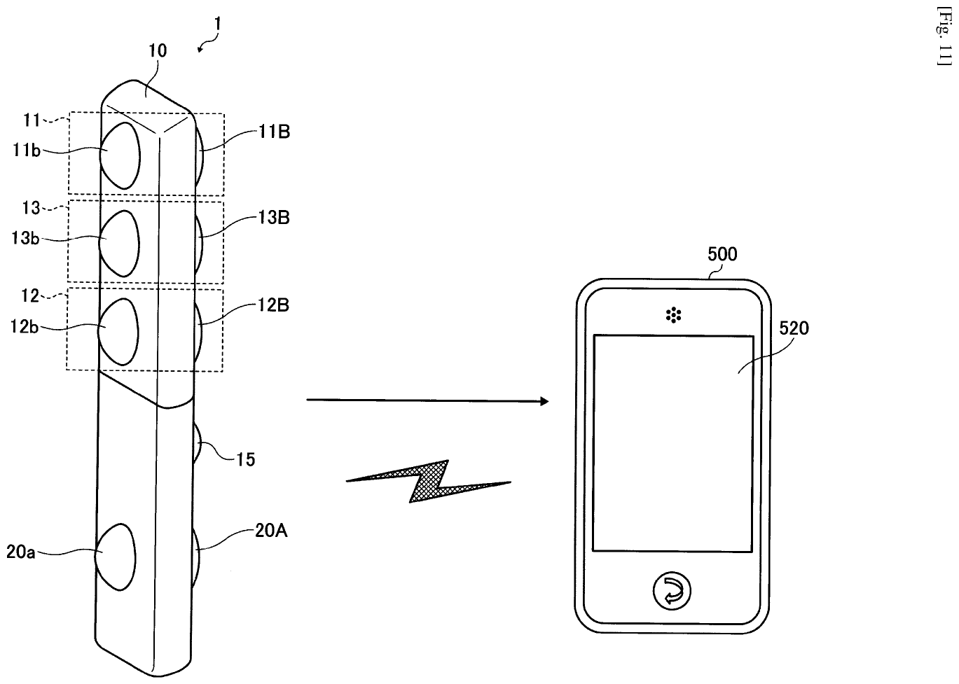

FIG. 9 is a view illustrating an appearance of an image pickup apparatus according to a variant of the embodiment; FIG. 10 is a diagram illustrating a configuration of a processing block of a processing circuit according to the variant.

In the present variant, the display control unit 170 obtains omnidirectional RGB image data from the RGB image data obtaining unit 142 and displays two-dimensional image information based on the obtained omnidirectional RGB image data on the display unit 520 of the display apparatus 500. The display unit 520 is an example of a destination to which the two-dimensional image information is output.

Therefore, it is possible to easily find from the two-dimensional image information displayed on the display unit 520 that the person who takes the image himself/herself, a tripod, or the like appears in the taken image or that the desired layout is not obtained.

The display control unit 170 outputs the two-dimensional image information to the display unit 520 different from the external apparatus 300 to which the transmitting and receiving unit 180 outputs the three-dimensional information.

Accordingly, it is possible to confirm that the person who takes the image himself/herself or a tripod does not appear in the taken image and that the three-dimensional information having the desired layout is obtained, from the two-dimensional image information output to the display unit 520 different from the external apparatus 300 without checking the three-dimensional information output to the external apparatus 300.

The display control unit 170 may obtain the three-dimensional data of the omnidirectional image from the three-dimensional reconstruction processing unit 150 and display the three-dimensional information on the display unit 520. Specifically, the display control unit 170 may select a case in which the two-dimensional image information is displayed on the display unit 520 or a case in which the three-dimensional information is displayed on the display unit 520 according to predetermined conditions. Accordingly, the display control unit 170 may output two-dimensional image information in addition to the three-dimensional information.

The display control unit 170 displays a display image including error information based on the error information obtained from the determining unit 160 and two-dimensional image information on the display unit 520.

The display control unit 170 displays on the display unit 520 a display image including identification information for identifying an adjacent object based on coordinate position information of the pixel obtained from the determining unit 160 and including two-dimensional image information.

That is, the display control unit 170 causes the display unit 520 to perform displaying differently depending on presence or absence of an adjacent object determined based on the output of the range information obtaining unit 13 and the output of the image pickup unit 11.

Thus, the person who takes an image can accurately find that the person who takes the image himself/herself or an adjacent object, such as a tripod, appears in the taken image, distinguishing the person who takes the image or an adjacent object, such as a tripod, from the effect of external light.

The display control unit 170 causes the display unit 520 to perform displaying differently at a position of the display unit 520 corresponding to the position of the adjacent object. This allows the person who takes the image to identify the position of the adjacent object appearing in the taken image.

The display control unit 170 displays image information captured by the image pickup unit 11 on the display unit 520 and displays a display image including identification information for identifying an adjacent object and including the image information on the display unit 520. This ensures that the person who takes the image can identify the position of the adjacent image appearing in the taken image.

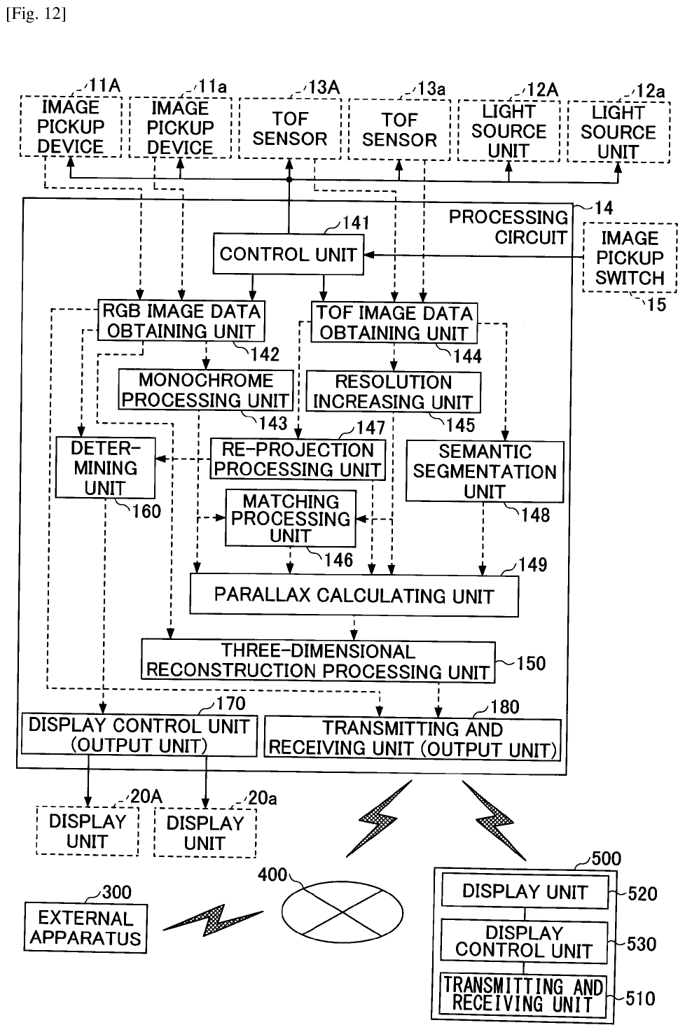

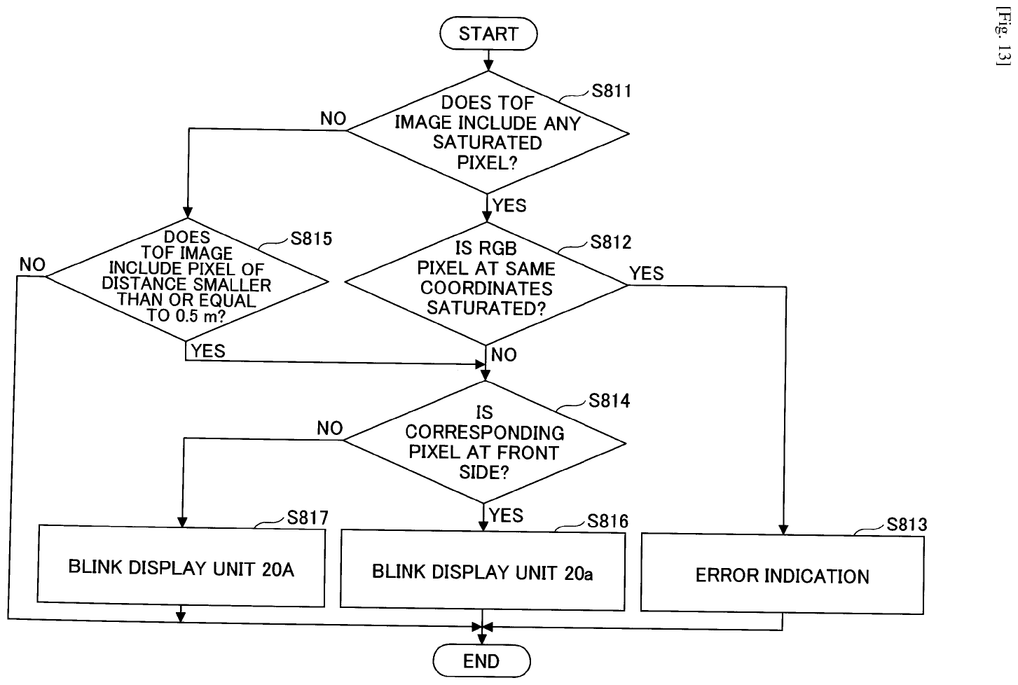

FIG. 11 is a view illustrating an appearance of an image pickup apparatus according to a second variant of the embodiment of the present invention. FIG. 12 is a diagram illustrating a configuration of a processing block of a processing circuit according to the second variant.

In the second variant depicted in FIG. 11, the image pickup apparatus 1 includes a plurality of display units 20A and 20a instead of the display unit 20 depicted in FIG. 1.

The display units 20A and 20a include LEDs or the like and are blinked or continuously lit according to an output signal of the processing circuit 14.

The display unit 20a is provided on a first surface at a front side of the housing 10, and the display unit 20A is provided on a second surface at a back side of the housing 10.

In the second variant depicted in FIG. 12, the display control unit 170 displays information indicating a determination result obtained from the determining unit 160 on the display units 20A and 20a. For example, the display units 20a and 20b may blink red when there is an adjacent object on each side of the image pickup apparatus 1.

The transmitting and receiving unit 180 transmits (outputs) omnidirectional two-dimensional image information output from the RGB image data obtaining unit 142 to the display apparatus 500 through the network 400. The display apparatus 500 is an example of an output destination to which two-dimensional image information is output.

That is, in the second variant, in Step S3 illustrated in FIG. 5, the transmitting and receiving unit 180 obtains omnidirectional RGB image data from the RGB image data obtaining unit 142 and transmits (outputs) the two-dimensional image information based on the obtained omnidirectional RGB image data to the display apparatus 500.

The transmitting and receiving unit 510 of the display apparatus 500 receives the two-dimensional image information transmitted from the transmitting and receiving unit 180 of the image pickup apparatus 1.

The display control unit 530 of the display apparatus 500 displays on the display unit 520 the two-dimensional image information received by the transmitting and receiving unit 510. The display apparatus 500 including the display control unit 530 is an example of an information processing apparatus.

As described above, the image pickup apparatus 1 includes the image pickup unit 11 and the transmitting and receiving unit 180 that outputs two-dimensional image information captured by the image pickup unit 11 in addition to the three-dimensional information.

Accordingly, it is possible to easily find from the two-dimensional image information that the person who takes the image himself/herself, a tripod, or the like appears in the taken image or that the desired layout is not obtained with respect to the three-dimensional information without checking the three-dimensional information.

Accordingly, it is possible to obtain the three-dimensional information again, if necessary, while being at the place where the three-dimensional information is obtained. Therefore, in comparison to a case where it is found after being away from the place where the three-dimensional information is obtained that the person who takes the image himself/herself, a tripod, or the like appears in the taken image or that the desired layout is not obtained with respect to the three-dimensional information, there is no need to again visit the place where the three-dimensional information is obtained.

The transmitting and receiving unit 180 transmits (outputs) the two-dimensional image information G in Step S3 before transmitting (outputting) the three-dimensional information in Step S11. The transmitting and receiving unit 180 transmits (outputs) the two-dimensional image information G in Step S3 before the three-dimensional re-construction processing unit 150 determines the three-dimensional information in Step S10.

Accordingly, it is possible to determine, on the basis of the two-dimensional image information, before checking the three-dimensional information, that the person who takes the image himself/herself, a tripod, or the like appears in the taken image or that the desired layout is not obtained.

The transmitting and receiving unit 180 transmits the two-dimensional image information to the display apparatus 500, and the display apparatus 500 displays the two-dimensional image information on the display unit 520.

Therefore, it is possible to easily find from the two-dimensional image information displayed on the display unit 520 that the person who takes the image himself/herself, a tripod, or the like appears in the taken image or that the desired layout is not obtained.

The transmitting and receiving unit 180 transmits the two-dimensional image information to the display apparatus 500 different from the external apparatus 300 to which the three-dimensional information is output.

Accordingly, it is possible to find that the person who takes the image himself/herself, a tripod, or the like appears in the taken image or that the desired layout is not obtained with respect to the three-dimensional information, from the two-dimensional image information output to the display unit 520 of the display apparatus 500 different from the external apparatus 300 without checking the three-dimensional information output to the external apparatus 300.

The transmitting and receiving unit 180 may transmit the three-dimensional information to the display apparatus 500. Specifically, the transmitting and receiving unit 180 may select a case in which the two-dimensional image information is transmitted to the display apparatus 500 or a case in which the three-dimensional information is transmitted to the display apparatus 500 according to predetermined conditions. Therefore, the transmitting and receiving unit 180 can transmit the two-dimensional image information to the display apparatus 500 in addition to the three-dimensional information.

FIG. 13 is a flow diagram of a process of identifying an adjacent object according to the second variant.

FIG. 13 is a flowchart illustrating a process of determining whether an adjacent object appears in the taken image according to the second variant, corresponding to Step S9 described in FIG. 5.

In Step S811, the determining unit 160 determines based on the omnidirectional TOF image data obtained from the reprojection processing unit 147 whether there is a pixel for which the charge stored amount is saturated as an example of a pixel for which the charge stored amount is more than or equal to a predetermined value in the omnidirectional TOF image data.

In Step S812, when there is a pixel for which the charge stored amount is saturated in Step S811, the determining unit 160 determines based on the omnidirectional RGB image data obtained from the RGB image data obtaining unit 142 whether the charge stored amount is saturated as an example of the charge stored amount being more than or equal to a predetermined value in the omnidirectional RGB image data for the pixel having the same coordinates as the pixel for which it is determined that the charge stored amount is saturated in Step S811.

When the charge stored amount is saturated in Step S812, the determining unit 160 determines that the charge stored amount is saturated in Step S811 due to external light and outputs error information to the display control unit 170. In Step S813, the display control unit 170 displays the error information on the display units 20A and 20a based on the error information obtained from the determining unit 160.

When the charge stored amount is not saturated in Step S812, the determining unit 160 determines that the charge stored amount is saturated in Step S811 due to presence of an adjacent object and outputs the coordinate position information of the pixel for which the charge stored amount is saturated in Step S811 to the display control unit 170. In Step S814, the display control unit 170 determines whether the coordinate position information indicates the front side of the housing 10 based on the coordinate position information of the pixel obtained from the determining unit 160.

In Step S815, when there is no pixel for which the charge stored amount is saturated in Step S811, the determining unit 160 determines based on the omnidirectional TOF image data obtained from the reprojection processing unit 147 whether there is any pixel having the range information of 0.5 m or less in the omnidirectional TOF image data.

When there is no pixel having the range information of 0.5 m or less in Step S815, the determining unit 160 ends the process.

When there is a pixel having the range information of 0.5 m or less in Step S815, the determining unit 160 proceeds to Step S814 as described above, determines that the pixel has the range information of 0.5 m or less as determined in Step S815 due to presence of an adjacent object, and outputs the coordinate position information of the pixel having the range information of 0.5 m or less determined in Step S815 to the display control unit 170. The display control unit 170 determines whether the coordinate position information indicates the front side of the housing 10 based on the coordinate position information of the pixel obtained from the determining unit 160.

In Step S816, the display control unit 170 blinks the display unit 20a disposed at the front side of the housing 10 when it is determined that the coordinate position information indicates the front side in Step S814.

In Step S817, the display control unit 170 blinks the display unit 20A at the back side of the housing 10 when it is not determined that the coordinate position information indicates the front side in Step S814.

As described above, the display control unit 170 blinks the display unit 20a or the display unit 20A when it is determined that an adjacent object is present, and does not blink either one of the display unit 20a and the display unit 20A when it is determined that no adjacent object is present.

That is, the display control unit 170 causes the display unit 20a and the display unit 20A to perform displaying differently depending on presence or absence of an adjacent object.

Thus, the person who takes the image can accurately find that the person who takes the image himself/herself, an adjacent object, such as a tripod, or the like appears in the taken image, distinguishing the person who takes the image himself/herself, an adjacent object, such as a tripod, or the like, from the effect of external light.

The display control unit 170 blinks the display unit 20a or the display unit 20A based on the coordinate position information of the pixel obtained from the determining unit 160.

That is, the display control unit 170 performs displaying at the display unit at a different position, that is, the display unit 20a or the display unit 20A, according to the position of the adjacent object. This allows the person who takes the image to identify the position of the adjacent object appearing in the taken image.

The display control unit 170 causes the display unit 20A or 20a nearer to the adjacent object to perform displaying differently depending on presence or absence of the adjacent object. This allows the person who takes the image to surely identify the position of a specific object appearing in the taken image.

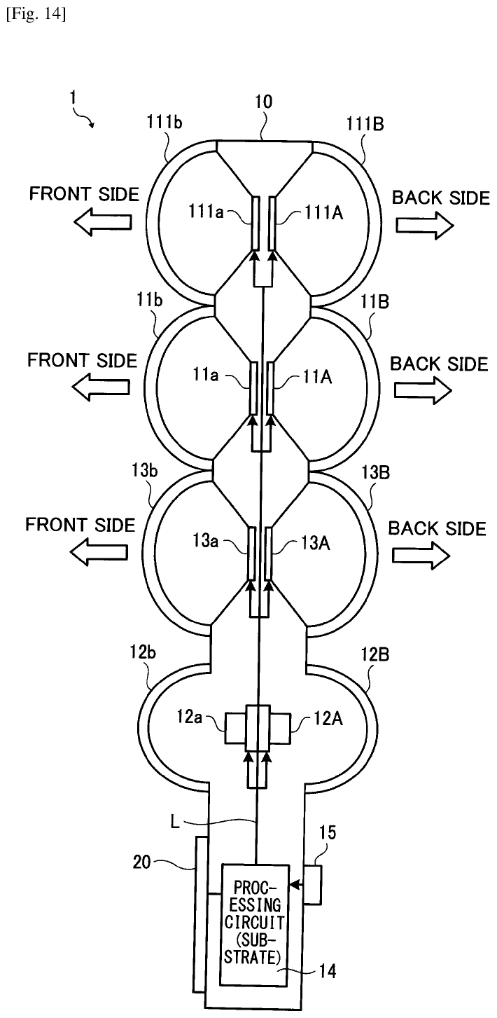

FIG. 14 is a diagram illustrating a configuration of an image pickup device according to a third variant of the embodiment of the present invention.

In the third variant depicted in FIG. 14, the image pickup apparatus 1 includes another image pickup unit 111 including other image pickup devices 111a and 111A and other fish-eye lenses (wide-angle lenses) 111b and 111B, in addition to the configuration depicted in FIG. 2.

In the third variant, the RGB image pickup unit 11 and the other image pickup unit 111 are set to have the same baseline. In this case, processing using multiple eyes is possible in the processing circuit 14. That is, by driving the image pickup unit 11 and the other image pickup unit 111 simultaneously provided at a predetermined distance on one plane, RGB images with respect to two points of view are obtained. This allows the use of parallax calculated based on the two RGB images and further improves the accuracy of distances throughout the measurement range.

Specifically, as a result of the RGB image pickup unit 11 and the other image pickup unit 111 being provided, a multi-baseline stereo (MSB) using SSD, EPI processing, or the like can be used as in conventional parallax calculation. Therefore, by using the configuration, the reliability of parallax is increased, and high spatial resolution and accuracy can be obtained.

As described above, the image pickup apparatus 1 includes the other image pickup unit 111, and the three-dimensional reconstruction processing unit 150 determines three-dimensional information based on the output of the range information obtaining unit 13, two-dimensional image information, and other two-dimensional image information captured by the other image pickup unit 111.

The image pickup apparatus 1 may include the other image pickup unit 111, and a three-dimensional information determining unit that determines three-dimensional information based on two-dimensional image information and other two-dimensional image information captured by the other image pickup unit 111 without using the output of the range information obtaining unit 13.

As a result, it is possible to find that the person who takes the image himself/herself, a tripod, or the like appears in the taken image or that the desired layout is not obtained with respect to three-dimensional information from two-dimensional image information captured by the image pickup unit 11, without checking three-dimensional information that is determined by the three-dimensional reconstruction processing unit 150 based on the two-dimensional image information.

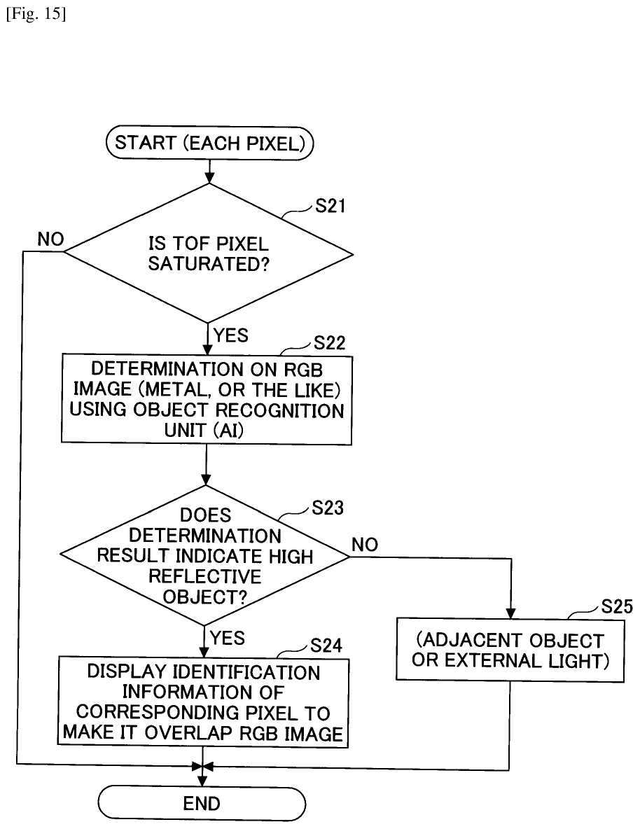

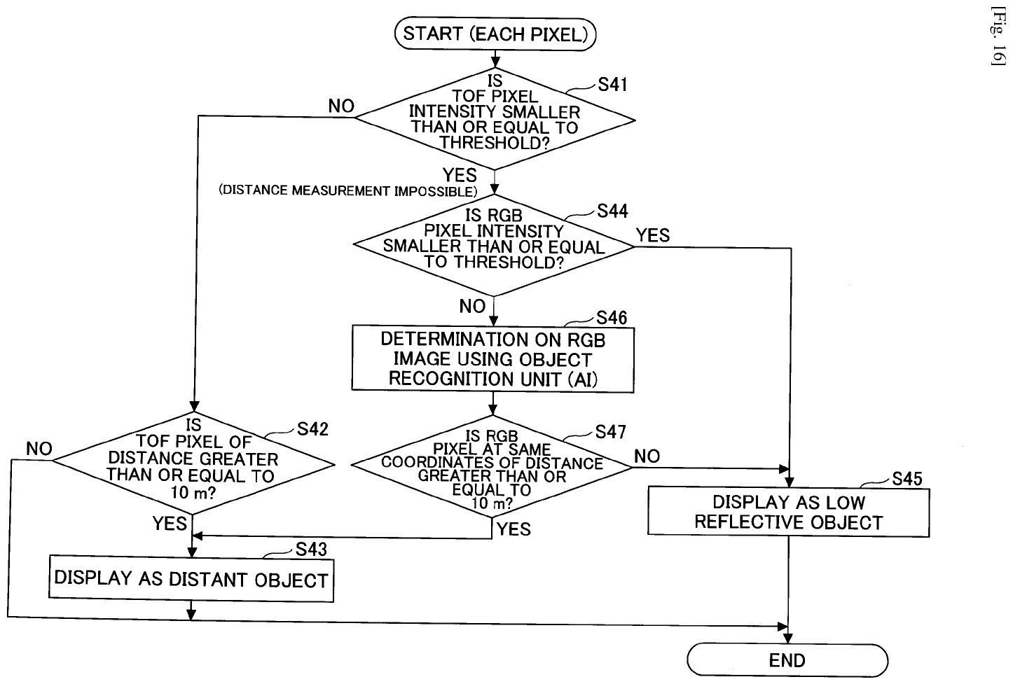

FIG. 15 is a flow diagram for identifying a high reflective object in accordance with the embodiment of the present invention, and is a flow chart illustrating a process for determining whether a high reflective object appears in the taken image, corresponding to Step S9 described in FIG. 5.

In Step S21, the determining unit 160 determines based on the omnidirectional TOF image data obtained from the reprojection processing unit 147 whether there is a pixel for which the charge stored amount is saturated as an example of a pixel for which the charge stored amount is more than or equal to a predetermined value in the omnidirectional TOF image data.

In Step S22, when there is a pixel for which the charge stored amount is saturated as determined in Step S21, the determining unit 160 determines based on the omnidirectional RGB image data obtained from the RGB image data obtaining unit 142 whether, in the omnidirectional RGB image data, the pixel of the same coordinates as the pixel for which the charge stored amount is saturated as determined in Step S21 corresponds to reference information with respect to a high reflective object. As the reference information with respect to a high reflective object, a model image may be used to determine a degree of coincidence between the RGB image data and the model image through an image recognition process. Alternatively, as the reference information indicating a high reflective object and the RGB image data, parameters such as spectra, colors, or the like may be used to determine the degree of coincidence based on a predetermined threshold. Further alternatively, the reference information may be stored as table data. In addition, Learning Model may be used.

The processing circuit 14 stores images of high reflective objects, such as images of a metal or a mirror, as model image information. In Step S22, the determining unit 160 determines whether the obtained image corresponds to any one of the images of the high reflective objects stored, using an determiner, such as a determiner using an AI technique.

In Step S23, the determining unit 160 outputs the coordinate position information of the pixel found in Step S22 to the display control unit 170 when it is determined that the image obtained in Step S22 corresponds to any one of the stored images of high reflective objects. The display control unit 170 displays a display image including identification information for identifying the high reflective object and the two-dimensional image information on the display unit 20 or 520 based on the coordinate position information of the pixel obtained from the determining unit 160 (Step S24), and ends the process.

Step S22 and Step S23 are examples of a determining step, and Step S24 is an example of a displaying step.

In Step S25, when it is determined that the image obtained in Step S22 does not coincide with the images of high reflective objects stored, the determining unit 160 proceeds to a determination of an adjacent object (Step S23) and performs an adjacent object determination flow depicted in FIG. 7.

As described above, the image pickup apparatus 1 includes the determining unit 160 for determining whether a high reflective object is present on the basis of both the output of the range information obtaining unit 13 and the output of the image pickup unit 11; and the display control unit 170 for causing the display unit 20 or 520 to perform displaying differently depending on presence or absence of a high reflective object.

This allows the person who takes the image to accurately find that a high reflective object, such as a minor, if any, appears in the taken image, distinguishing the high reflective object from effects of an adjacent object or external light.

The image pickup apparatus 1 includes the display unit 20. This allows the person who takes the image to ensure that a high reflective object appear in the taken image.

The display control unit 170 causes the display unit 20 or 520 to perform displaying differently at a position of the display unit 20 or 520 corresponding to the position of the high reflective object. This allows the person who takes the image to identify the position of the high reflective object.

Similar to the case of an adjacent object described above with reference to FIG. 13, the display unit 20 includes the plurality of display units 20A and 20a, and the display control unit 170 causes the display unit nearer to the high reflective object from among the plurality of display units 20A and 20a to perform displaying differently depending on presence or absence of the object. This allows the person who takes the image to surely identify the position of the high reflective object.

Similar to the case of an adjacent object described above with reference to FIG. 3, the display control unit 170 displays image information G captured by the image pickup unit 11 on the display unit 20 or 520 and displays a display image including identification information for identifying a high reflective object and the image information G on the display unit 20 or 520. This allows the person who takes the image to surely identify the position of the high reflective object.

The determining unit 160 determines that there is a high reflective object when the charge stored amount is saturated at a pixel as an example of a pixel in which the charge stored amount with respect to light received by the range information obtaining unit 13 is more than or equal to a predetermined value, and when the image information captured by the image pickup unit coincides with model image information as an example of reference information with respect to a high reflective object.

This allows the person who takes the image to accurately find that a high reflective object appears in the taken image, distinguishing the high reflective object from effects of an adjacent object or external light.

The image pickup apparatus 1 obtains range information with respect to an object based on light received by the range information obtaining unit 13. In this case, the person who takes the image can understand that the cause of not being able to obtain the desired range information is not an adjacent object or external light but a high reflective object.

The image pickup apparatus 1 includes the transmitting and receiving unit 180 that outputs three-dimensional information determined based on the range information obtained from the range information obtaining unit 13. In this case, the person who takes the image can understand that the cause of not being able to obtain the desired three-dimensional information is a high reflective object, not an adjacent object or external light.

FIG. 16 is a flow diagram illustrating determination with respect to a distant object and a low reflective object in the present embodiment, and is a flow chart depicting a process of determining whether the distant object or the low reflective object appears in the taken image, corresponding to Step S9 described in FIG. 5.

In Step S41, the determining unit 160 determines whether there is a pixel in the omnidirectional TOF image data whose charge stored amount is less than or equal to a threshold of being able to obtain range information based on the omnidirectional TOF image data obtained from the reprojection processing unit 147.

In Step S42, when there is no pixel whose storage amount is less than or equal to the threshold in Step S41, the determining unit 160 determines whether there is a pixel having the range information of 10 m or more in the omnidirectional TOF image data based on the omnidirectional TOF image data obtained from the reprojection processing unit 147. When there is a pixel having the range information of 10 m or more, the determining unit 160 determines that the pixel corresponds to a distant object and outputs the coordinate position information of the pixel to the display control unit 170.

The display control unit 170 displays the display image including identification information for identifying the distant object and two-dimensional image information on the display unit 20 or 520 based on the coordinate position information of the pixel obtained from the determining unit 160 (Step S43), and ends the process.

When there is no pixel having the range information of 10 m or more in Step S42, the determining unit 160 ends the process.

In Step S44, when there is a pixel whose charge stored amount is less than or equal to the threshold in Step S41, the determining unit 160 determines based on the omnidirectional RGB image data obtained from the RGB image data obtaining unit 142 whether the charge stored amount is less than or equal to a threshold of being able to identify an object with respect to a pixel in the omnidirectional RGB image data, the pixel having the same coordinates as the coordinates of the pixel whose charge stored amount is less than or equal to the threshold in Step S41.

When it is determined in Step S44 that the charge stored amount is less than or equal to the threshold for of able to identify an object, the determining unit 160 determines that the pixel corresponds to a low reflective object and outputs the coordinate position information of the pixel to the display control unit 170.

The display control unit 170 displays a display image including identification information for identifying the low reflective object and two-dimensional image information on the display unit 20 or 520 based on the coordinate position information of the pixel obtained from the determining unit 160 (Step S45), and ends the process.

In Step S46, when it is determined in Step S44 that the charge stored amount is more than the threshold of being able to identify an object, the determining unit 160 determines the distance with respect to the RGB image data including the pixel found in Step S44 based on model information that is an example of reference information in which distances are associated with images. When a model image is thus used as the reference information, the degree of coincidence between the RGB image data and the model image may be determined by image recognition. In addition, with regard to the reference information and the RGB image data, parameters may be used to determine the degree of coincidence based on a predetermined threshold. In addition, the reference information may be stored in a table, or Learning Model may be used.

The processing circuit 14 stores an image associated with a distance for each of a plurality of distances as the model information. In Step S46, the determining unit 160 determines whether the obtained image coincides with the image on a per distance basis included in the plurality of distances using a determiner such as a determiner using an AI technique.

In Step S47, the determining unit 160 determines whether the distance associated with the image obtained in Step S46 is 10 m or more; and, when having determined that the distance is 10 m or more, the determining unit 160 determines that the pixel corresponds to a distant object, outputs the coordinate position information of the pixel to the display control unit 170, and proceeds to Step S43.

When the distance associated with the image obtained in Step S46 is less than 10 m, the determining unit 160 determines that the pixel corresponds to a low reflective object, outputs the coordinate position information of the pixel to the display control unit 170 (Step S47), and proceeds to Step S45.

Steps S41, S42, S44, and S47 are examples of determination steps, and Steps S43 and S45 are examples of displaying steps.

As described above, the image pickup apparatus 1 includes the determining unit 160 for determining whether there is a distant object or a low reflective object based on both an output of the range information obtaining unit 13 and an output of the image pickup unit 11, and the display control unit 170 for causing the display unit 20 or 520 to perform displaying differently depending on presence or absence of a distant object or a low reflective object.

This allows the person who takes the image to accurately determine that a distant object or a low reflective object, such as a black object, appears in the taken image.

The image pickup apparatus 1 includes the display unit 20. This allows the person who takes the image to surely understand that the taken image contains an image of either a distant object or a low reflective object.

The display control unit 170 causes the display unit 20 or 520 to perform displaying differently at a position of the display unit 20 or 520 corresponding to the position of the distant object or the low reflective object. This allows the person who takes the image to identify the position of the distant object or the low reflective object.

Similar to the case of an adjacent object described above with reference to FIG. 13, the display unit 20 includes the plurality of display units 20A and 20a, and the display control unit 170 causes the display unit from among the plurality of display units 20A and 20a nearer to the distant object or the low reflective object to perform displaying differently depending on presence or absence of the object. This allows the person who takes the image to surely identify the position of the distant object or the low reflective object.

Similar to the case of an adjacent object described above with reference to FIG. 3, the display control unit 170 displays the image information G captured by the image pickup unit 11 on the display unit 20 or 520 and displays a display image on the display unit 20 or 520 including identification information for identifying a distant object or a low reflective object and the image information G. This allows the person who takes the image to surely identify the position of the distant object or the low reflective object.

When the charge stored amount for a pixel with respect to light received by the range information obtaining unit 13 is less than or equal to a threshold, the determining unit 160 determines whether the pixel corresponds to a low reflective object or a distant object based on the output of the image pickup unit 11. This allows the person who takes the image to accurately find that a low reflective object or a distant object appears in the taken image.

The determining unit 160 determines that there is a low reflective object when the charge stored amount corresponding to the pixel with respect to the light received by the range information obtaining unit 13 is less than or equal to the threshold and the charge stored amount corresponding to the pixel of the image pickup unit 11 is less than or equal to a threshold. This allows the person who takes the image to accurately find that a low reflective object appears in the taken image.

When the charge stored amount corresponding to the pixel with respect to the light received by the range information obtaining unit 13 is less than or equal to the threshold, the charge stored amount corresponding to the pixel of the image pickup unit 11 is more than or equal to the threshold, and the distance determined based on the pixel is more than or equal to a threshold, the determining unit 160 determines that the pixel corresponds to a distant object.

This allows the person who takes the image to accurately find that a distant object appears in the taken image.

The image pickup apparatus 1 obtains range information with respect to an object based on the light received by the range information obtaining unit 13. In this case, the person who takes the image can understand that the cause of not being able to obtain the desired range information is a distant object or a low reflective object.

The image pickup apparatus 1 includes the transmitting and receiving unit 180 as an example of an output unit that outputs three-dimensional information determined based on range information obtained from the range information obtaining unit 13. In this case, the person who takes the image can understand that the cause of not being able to obtain the desired three-dimensional information is a distant object or a low reflective object.

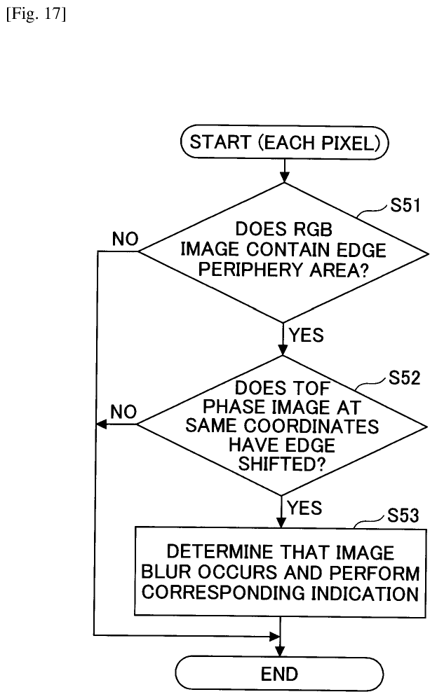

FIG. 17 is a flowchart illustrating a determination process for presence or absence of an image blur in the taken image, corresponding to Step S9 described in FIG. 5.

In Step S51, the determining unit 160 determines whether there is a pixel of an image including an image of an edge peripheral area in an omnidirectional RGB image based on omnidirectional RGB image data obtained from the RGB image data obtaining unit 142.

The determining unit 160 detects an edge appearing in the taken image and identifies the pixel of the image including the image of the edge peripheral area using a change in the brightness value of the pixel or from comparing the first or second derivative thereof, for example, with a threshold, but may detect the edge by another method.

Next, in Step S52, when there is a pixel of an image including an image of an edge peripheral area in Step S51, TOF image data included in the omnidirectional TOF image data obtained from the reprojection processing unit 147 and including a pixel having the same coordinates as the coordinates of the pixel of the image that has been determined to include the image of the edge peripheral area in Step S51 is used to determine based on the TOF image data whether the edge of a TOF phase image is shifted, and when it is determined that the edge is shifted, the coordinate position information of the pixel that is found in Step S51 is output to the display control unit 170.

The display control unit 170 displays a display image including identification information for indicating an image blur and two-dimensional image information on the display unit 20 or 520 (Step S53) based on the coordinate position information of the pixel obtained from the determining unit 160, and ends the process.

Steps S51 and S52 are examples of determination steps, and Step S53 is an example of a displaying step.

When there is no pixel corresponding to an image including an image of an edge peripheral area in Step S51 or when the edge of the TOF phase image is not shifted in Step S52, the determining unit 160 ends the process.

In the present embodiment, the distance is measured by the phase difference detection method, and, for each of 0°, 90°, 180°, and 270° phases, the image pickup apparatus 1 obtains N TOF phase images of the same phase and adds them together.

By thus adding together N phase images of the same phase, the dynamic range of the phase image with respect to the corresponding phase is widened. In addition, the time required for capturing the N phase images that are added together for each phase is shortened, so that a phase image with superior position accuracy that is less influenced by an image blur or the like is obtained. For this reason, a process of detecting an image shifted amount depicted below can be performed accurately using a phase image with the widened dynamic range.

The determining unit 160 may finally determine whether there is an image blur, by calculating a pixel shifted amount for each phase through a common process to determine an optical flow or using machine learning technology disclosed in the reference paper depicted below, and comparing the value obtained by adding together the thus calculated pixel shifted amounts on a per phase basis with a threshold. However, the determining unit 160 may determine whether there is an image blur by another method.

Name of paper: Tackling three-dimensional ToF Artifacts Through Learning and the FLAT Dataset

Author: Qi Guo (SEAS, Harvard University); Iuri Frosio; Orazio Gallo; Todd Zickler (SEAS, Harvard University); Jan Kautz

Published date: Monday, Sep. 10, 2018 Publisher: ECCV (European Conference on Computer Vision) 2018 URL (Uniform Resource Locator): https://research.nvidia.com/publication/2018-09_Tackling-three-dimensional-ToF

As described above, the image pickup apparatus 1 includes the determining unit 160 for determining whether there is an image blur based on both the output of the range information obtaining unit 13 and the output of the image pickup unit 11, and the display control unit 170 for causing the display unit 20 or 520 to perform displaying differently depending on presence or absence of an image blur.

This allows the person who takes the image to accurately find that an image blur appears in the taken image.

The image pickup apparatus 1 includes the display unit 20. This allows the person who takes the image to accurately find that an image blur appears in the taken image.

The display control unit 170 causes the display unit 20 or 520 to perform displaying differently at a position of the display unit 20 or 520 corresponding to the position at which an image blur occurs. This allows the person who takes the image to identify the position at which the image blur occurs.

Similarly to the case of an adjacent object described above with reference to FIG. 13, the display unit 20 includes the plurality of display units 20A and 20a, and the display control unit 170 causes the display unit from among the plurality of display units 20A and 20a nearer the position at which the image blur occur to perform displaying differently depending on presence or absence of the image blur. This allows the person who takes the image to surely identify the position of the image blur.

Similar to a case of an adjacent object described above with reference to FIG. 3, the display control unit 170 displays the image information G captured by the image pickup unit 11 on the display unit 20 or 520 and displays the display image including identification information for indicating an image blur and the image information G on the display unit 20 or 520. This allows the person who takes the image to surely identify the position of the image blur.

The determining unit 160 determines that there is an image blur, when an edge of an image is detected based on the image information captured by the image pickup unit 11 and a shift of the corresponding pixel with respect to light received by the range information obtaining unit 13 is detected.

This allows the person who takes the image to accurately find that an image blur appears in the taken image.

The image pickup apparatus 1 obtains range information with respect to an object based on the light received by the range information obtaining unit 13. In this case, the person who takes the image can find that the cause of not being able to obtain the desired range information is an image blur.

The image pickup apparatus 1 includes the transmitting and receiving unit 180 as an example of an output unit that outputs three-dimensional information determined based on range information obtained from the range information obtaining unit 13. In this case, the person who takes the image can find that the cause of not being able to obtain the desired three-dimensional information is an image blur.

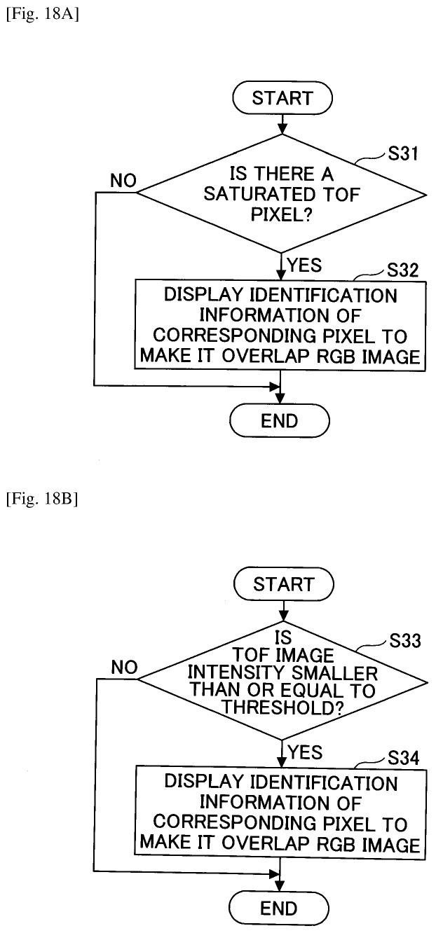

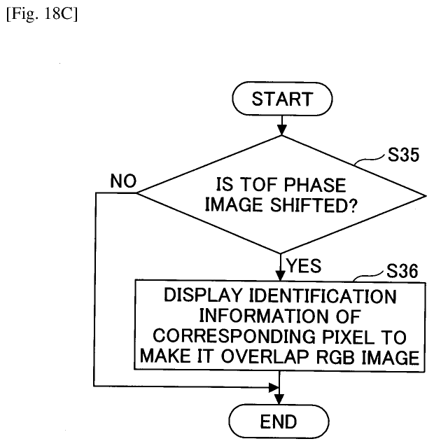

FIGS. 18A-18C are determination flow diagrams according to a fourth variant of the embodiment of the present invention.

In Step S9 described in FIG. 5, the determining unit 160 determines presence or absence of a specific object, such as an adjacent object, and the display control unit 170 causes the display unit 20 or 520 to perform displaying differently depending on presence or absence of a specific object. However, in the fourth variant, the determining unit 160 does not determine presence or absence of a specific object, and the display control unit 170 does not cause the display unit 20 or 520 to perform displaying differently depending on presence or absence of a specific object, but allow the user to identify a specific object, as will be described below.

In the flow depicted in FIG. 18A, based on the omnidirectional TOF image data obtained from the reprojection processing unit 147, in Step S31, the determining unit 160 determines whether there is a pixel whose charge stored amount is saturated as an example of a pixel whose charge stored amount is more than or equal to a predetermined value and whose range information is more than or equal to a threshold, and if there is a pixel whose charge stored amount is more than or equal to a threshold, outputs the coordinate position information of the pixel to the display control unit 170.

Based on the coordinate position information of the pixel obtained from the determining unit 160, the display control unit 170 displays a display image including position identification information for identifying the position and the two-dimensional image information on the display unit 20 or 520 (Step S32) in the same manner as the case of an adjacent object described above with reference to in FIG. 3, and ends the process.

The determining unit 160 ends the process when the charge stored amount is less than the threshold in Step S31.

In the flow depicted in FIG. 18B, the determining unit 160 determines whether there is a pixel in the omnidirectional TOF image data whose charge stored amount is less than or equal to a threshold for being able to obtain range information based on the omnidirectional TOF image data obtained from the reprojection processing unit 147, and outputs the coordinate position information of the pixel to the display control unit 170 when there is the pixel whose charge stored amount is less than or equal to the threshold (Step S33).

In Step S34, The display control unit 170 displays the display image including position identification information for identifying the position and the two-dimensional image information on the display unit 20 or 520 in the same manner as the case of an adjacent object described above with reference to FIG. 3 based on the coordinate position information of the pixel obtained from the determining unit 160, and ends the process.

The determining unit 160 ends the process when the charge stored amount is more than the threshold in Step S33.

In the flow depicted in FIG. 18C, the determining unit 160 determines whether there is a pixel in the omnidirectional TOF image data, the pixel being a pixel with respect to which the TOF phase image is shifted and the range information cannot be obtained, based on the omnidirectional TOF image data obtained from the reprojection processing unit 147. When there is the pixel with respect to which the TOF phase image is shifted, the determining unit 160 outputs the coordinate position information of the pixel to the display control unit 170 (Step S35).

The determining unit 160 determines whether the TOF phase image is shifted by the same method as the method described with regard to Step S52 of FIG. 17.

The display control unit 170 displays the display image including position identification information for identifying the position and the two-dimensional image information on the display units 20 and 520 (Step S36) in the same manner as the case of an adjacent object described above with reference to FIG. 3 based on the coordinate position information of the pixel obtained from the determining unit 160, and ends the process.

When there is no pixel with respect to which the TOF phase image is shifted, the determining unit 160 ends the process.

As described above, the image pickup apparatus 1 includes the display control unit 170 for displaying on the display unit 20 or 520 a display image including position identification information for identifying a position based on position information indicating a position determined by the determining unit 160 having determined whether an output of the range information obtaining unit 13 is more than or equal to a threshold or is less than or equal to a threshold, and including two-dimensional image information G captured by the image pickup unit 11 that captures an image of an object.

Therefore, by finding the position where the output of the range information obtaining unit 13 is more than or equal to a threshold or is less than or equal to a threshold, that is, the position where the output of the range information obtaining unit 13 is too strong or too weak to obtain the desired output, the cause of not being able to obtain the desired output can be understood using the two-dimensional image G.

The image pickup apparatus 1 includes the display control unit 170 for displaying on the display unit 20 or 520 a display image including position identification information for identifying a position based on position information determined by the determining unit 160 as a position for which it is not possible to obtain range information with respect to the object based on the output of the range information obtaining unit 13; the display image further includes two-dimensional image information G captured by the image pickup unit 11 that captures an image of an object.

Therefore, by identifying the position where the range information with respect to the object cannot be obtained from the two-dimensional image G, the cause of not being able to obtain the range information with respect to the object can be understood.

The determining units 160, 560, and 660 determine that the distance information with respect to the object cannot be obtained not only when the output of the range information obtaining unit 13 is more than or equal to a threshold or is less than or equal to a threshold but also when an image blur is detected from the output of the range information obtaining unit 13.

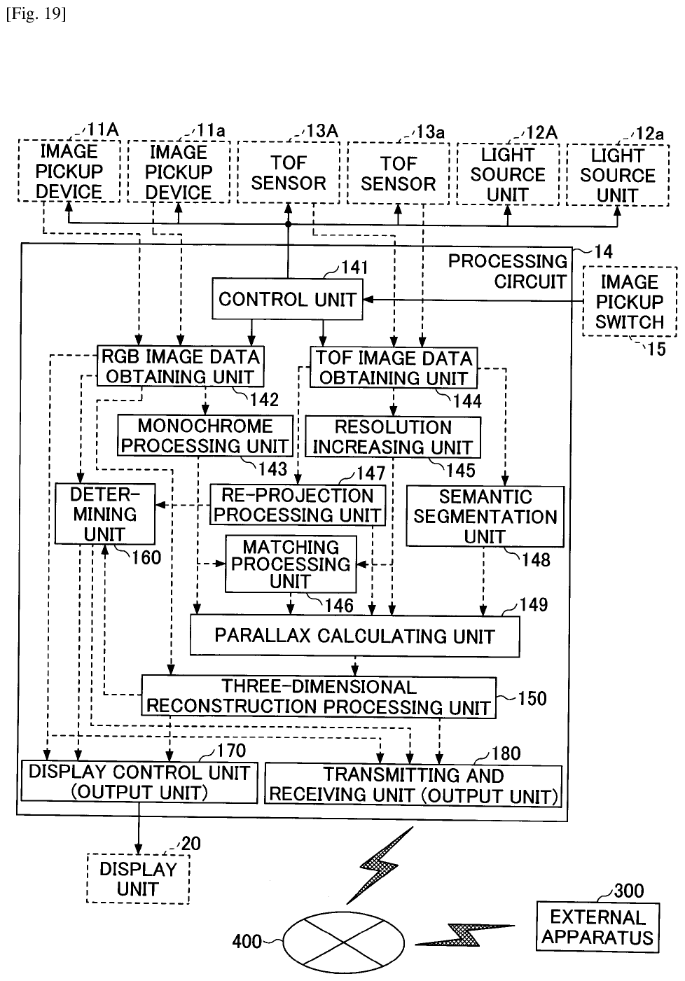

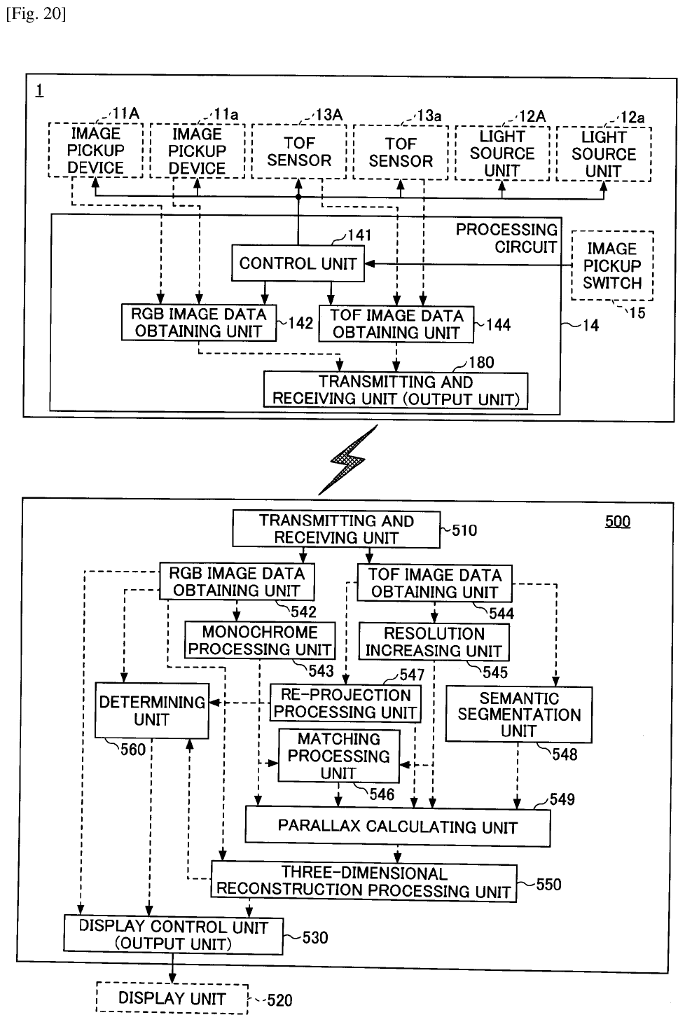

FIG. 19 is a diagram illustrating an example of a configuration of a processing block of a processing circuit according to a fifth variant of the embodiment of the present invention.

The processing block of the processing circuit according to the fifth variant depicted in FIG. 19 is different from the processing block of the processing circuit 14 according to the present embodiment depicted in FIG. 4 in that the determining unit 160 outputs a determination result to the transmitting and receiving unit 180, obtains omnidirectional three-dimensional data from the three-dimensional reconstruction processing unit 150, and outputs a determination result to the transmitting and receiving unit 180, and the display control unit 170 obtains the omnidirectional three-dimensional data from the three-dimensional reconstruction processing unit 150.

The transmitting and receiving unit 180 transmits (outputs), via the network 400, the determination result of the determining unit 160 to the external apparatus 300 that performs the three-dimensional restoration process, in addition to the omnidirectional three-dimensional data output from the three-dimensional reconstruction processing unit 150 and the omnidirectional two-dimensional image information output from the RGB image data obtaining unit 142.

The display control unit 170 displays a three-dimensional image on the display unit 20 based on the omnidirectional three-dimensional data obtained from the three-dimensional reconstruction processing unit 150, and displays on the display unit 20 a display image including identification information for identifying a specific object based on the determination result of the determining unit 160 that determines whether a specific object is present on the basis of both the output of the image pickup unit 11 and the output of the range information obtaining unit 13, and including a three-dimensional image. The specific object may be an adjacent object, a high reflective object, a distant object, a low reflective object, or an image blur area.

This allows identifying the cause of the desired three-dimensional image 3G being not displayed as an adjacent object, a high reflective object, a distant object, a low reflective object, or an image blur, by viewing a three-dimensional image 3G.

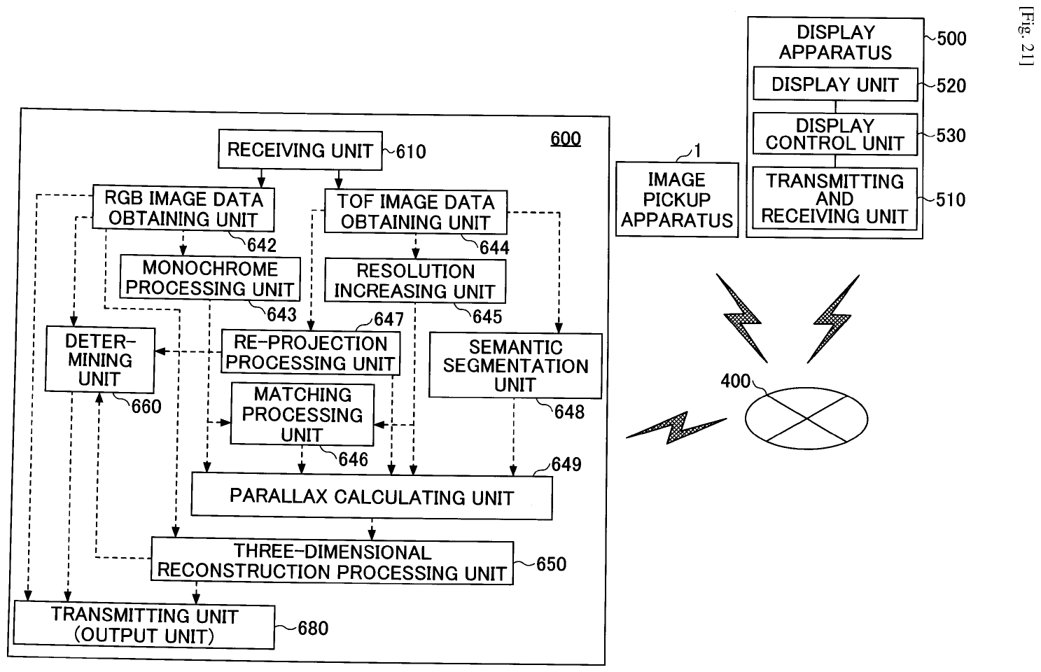

FIG. 20 is a diagram depicting an example of a configuration of an information processing system according to a sixth variant of the embodiment of the present invention.

The information processing system according to the sixth variant depicted in FIG. 20 includes the image pickup apparatus 1 and the display apparatus 500.

The image pickup apparatus 1 depicted in FIG. 20 includes the image pickup devices 11a and 11A, the TOF sensors 13a and 13A, the light source units 12a and 12A, and the image pickup switch 15, which are configured to be the same as or similar to the corresponding devices depicted in FIG. 4.

The processing circuit 4 of the image pickup apparatus 1 depicted in FIG. 20 includes the control unit 141, the RGB image data obtaining unit 142, the TOF image data obtaining unit 144, and the transmitting and receiving unit 180. The control unit 141 is configured to be the same as or similar to the control unit 141 depicted in FIG. 4.

Similarly to FIG. 4, the RGB image data obtaining unit 142 obtains the RGB image data captured by the image pickup devices 11a and 11A based on an image pickup instructions from the control unit 141 and outputs the omnidirectional RGB image data. However, the output destination of the RGB image data is different from the output destination of the RGB image data of FIG. 4 in that the output destination is the transmitting and receiving unit 180.

Similar to FIG. 4, the TOF image data obtaining unit 144 obtains TOF image data generated by the TOF sensors 13a and 13A and outputs the omnidirectional TOF image data based on instructions for generating TOF image data from the control unit 141. However, the output destination of the TOF image data obtaining unit 144 differs from the output destination of the TOF image data obtaining unit 144 of FIG. 4 in that the output destination is the transmitting and receiving unit 180.

Unlike FIG. 4, the transmitting and receiving unit 180 transmits (outputs) the omnidirectional RGB image data output from the RGB image data obtaining unit 142 and the omnidirectional TOF image data output from the TOF image data obtaining unit 144 to the display apparatus 500.

The display apparatus 500 illustrated in FIG. 20 includes a transmitting and receiving unit 510, the display unit 520, and a display control unit 530 the same as or similar to the corresponding units of the second variant illustrated in FIG. 12; and further includes a RGB image data obtaining unit 542, a monochrome processing unit 543, a TOF image data obtaining unit 544, a resolution increasing unit 545, a matching processing unit 546, a reprojection processing unit 547, a semantic segmentation unit 548, a parallax calculating unit 549, a three-dimensional reconstruction processing unit 550, and a determining unit 560.

The transmitting and receiving unit 510 receives the omnidirectional RGB image data and the omnidirectional TOF image data transmitted from the image pickup apparatus 1.

The RGB image data obtaining unit 542 obtains the omnidirectional RGB image data from the transmitting and receiving unit 510, and the TOF image data obtaining unit 544 obtains the omnidirectional RGB image data from the transmitting and receiving unit 510. Except for these points, the RGB image data obtaining unit 542 and the TOF image data obtaining unit 544 are configured to be the same as or similar to the RGB image data obtaining unit 142 and the TOF image data obtaining unit 144, respectively.

The monochrome processing unit 543, the TOF image data obtaining unit 544, the resolution increasing unit 545, the matching processing unit 546, the reprojection processing unit 547, the semantic segmentation unit 548, the parallax calculating unit 549, the three-dimensional reconstruction processing unit 550, and the determining unit 560 are configured to be the same as or similar to the monochrome processing unit 143, the TOF image data obtaining unit 144, the resolution increasing unit 145, the matching processing unit 146, the reprojection processing unit 147, the semantic segmentation unit 148, the parallax calculating unit 149, the three-dimensional reconstruction processing unit 150, and the determining unit 160 illustrated in FIG. 4.

The display control unit 530 may obtain the omnidirectional RGB image data from the RGB image data obtaining unit 542 and display a two-dimensional image based on the obtained omnidirectional RGB image data on the display unit 520, or may obtain the omnidirectional three-dimensional data from the three-dimensional reconstruction processing unit 545, and display the three-dimensional image on the display unit 520.

The display control unit 530 displays on the display unit 520 a display image including information indicating the determination result obtained from the determining unit 160 and a two-dimensional image or a three-dimensional image.

As described above, the display apparatus 500 includes the transmitting and receiving unit 510 as an example of a receiving unit that receives an output of the image pickup unit 11 that captures an image of an object, and receives an output of the range information obtaining unit 13 that projects light to an object and receives light reflected from the object, the determining unit 560 for determining whether a specific object exists on the basis of both the output of the range information obtaining unit 13 and the output of the image pickup unit 11 received by the transmitting and receiving unit 510, and the display control unit 530 for causing the display unit 520 to perform displaying differently depending on presence or absence of a specific object based on the determination result of the determining unit 560.

The specific object may be an adjacent object, a high reflective object, a distant object, a low reflective object, or an image blur area.

The display apparatus 500 includes the display control unit 530 for displaying a display image on the display unit 520 including identification information for identifying a specific object based on a determination result of the determining unit 560 by which presence or absence of a specific object is determined based on both an output of the image pickup unit 11 that captures an image of an object and an output of the range information obtaining unit 13 for receiving light projected to the object and reflected from the object; the display image further includes a three-dimensional image 3G determined by the three-dimensional reconstruction processing unit 550.

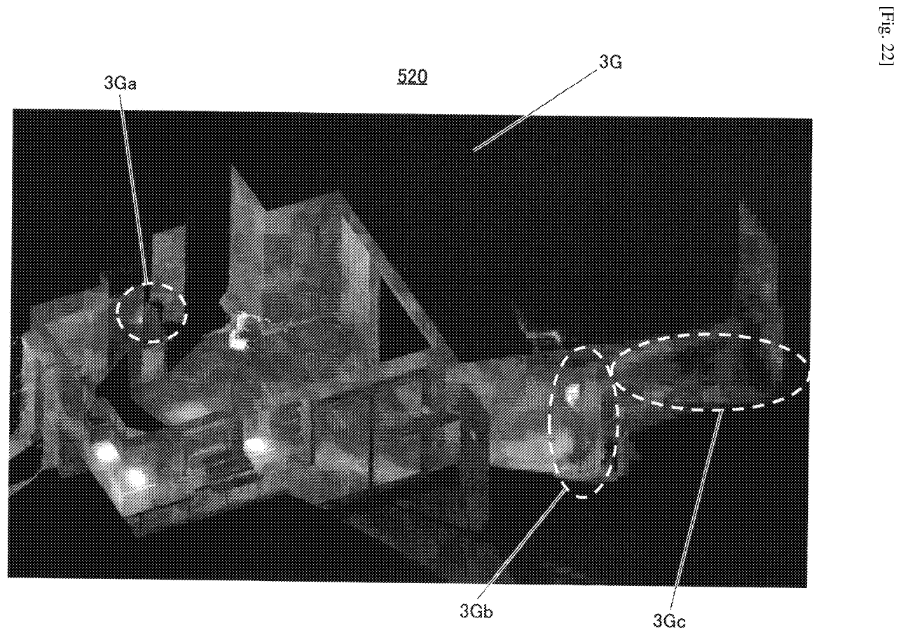

FIG. 21 is a diagram depicting an example of the configuration of an information processing system according to a seventh variant of the embodiment of the present invention.

The information processing system according to the seventh variant depicted in FIG. 21 includes the image pickup apparatus 1, the display apparatus 500, and a server 600.

The image pickup apparatus 1 illustrated in FIG. 21 is configured to be the same as or similar to the image pickup apparatus 1 illustrated in FIG. 20, and the display apparatus 500 illustrated in FIG. 21 is configured be the same as or similar to the display apparatus 500 illustrated in FIG. 12.

The server 600 illustrated in FIG. 21 includes a receiving unit 610, an RGB image data obtaining unit 642, a monochrome processing unit 643, a TOF image data obtaining unit 644, a resolution increasing unit 645, a matching processing unit 646, a reprojection processing unit 647, a semantic segmentation unit 648, a parallax calculating unit 649, a three-dimensional reconstruction processing unit 650, a determining unit 660, and a transmitting unit 680.

The receiving unit 610 receives the omnidirectional RGB image data and the omnidirectional TOF image data transmitted from the image pickup apparatus 1 via the network 400.

The RGB image data obtaining unit 642 obtains the omnidirectional RGB image data from the receiving unit 610, and the TOF image data obtaining unit 644 obtains the omnidirectional RGB image data from the receiving unit 610, but, except for these functions, these units 642 and 644 are configured to be the same as or similar to the RGB image data obtaining unit 142 and the TOF image data obtaining unit 144 illustrated in FIG. 4, respectively.

The monochrome processing unit 643, the TOF image data obtaining unit 644, the resolution increasing unit 645, the matching processing unit 646, the reprojection processing unit 647, the semantic segmentation unit 648, the parallax calculating unit 649, the three-dimensional reconstruction processing unit 650, and the determining unit 660 are the same as or similar to the monochrome processing unit 143, the TOF image data obtaining unit 144, the resolution increasing unit 145, the matching processing unit 146, the reprojection processing unit 147, the semantic segmentation unit 148, the parallax calculating unit 149, the three-dimensional reconstruction processing unit 150, and the determining unit 160 depicted in FIG. 4.

The transmitting unit 680 transmits (outputs) the omnidirectional three-dimensional data output from the three-dimensional reconstruction processing unit 650, the omnidirectional two-dimensional image information output from the RGB image data obtaining unit 642, and the determination result of the determining unit 660 to the display apparatus 500 through the network 400.

The transmitting and receiving unit 510 of the display apparatus 500 receives the omnidirectional three-dimensional data, the two-dimensional image information, and the determination result of the determining unit 160 transmitted from the server 600.

The display control unit 530 of the display apparatus 500 may obtain the omnidirectional RGB image data from the transmitting and receiving unit 510, and display a two-dimensional image based on the obtained omnidirectional RGB image data on the display unit 520; and may obtain the omnidirectional three-dimensional data from the transmitting and receiving unit 510, and display the three-dimensional image on the display unit 520.

The display control unit 530 displays a display image that includes information indicating the determination result obtained from the transmitting and receiving unit 510 and includes a two-dimensional image or a three-dimensional image on the display unit 520.

As described above, the display apparatus 500 includes the transmitting and receiving unit 510 for receiving the determination result from the determining unit 660 of the server 600 as to whether a specific object is present based on both the output of the image pickup unit 11 for capturing an image of an object and the output of the range information obtaining unit 13 for receiving light projected to an object and reflected from the object, and the display control unit 530 for causing the display unit 520 to perform displaying differently depending on presence or absence of the specific object based on the determination result received by the transmitting and receiving unit 510. The specific object may be an adjacent object, a high reflective object, a distant object, a low reflective object, or an image blur area.

The display apparatus 500 includes the display control unit 530 for displaying a display image on the display unit 520 including identification information for identifying a specific object based on a determination result of the determining unit 660 that determines whether a specific object is present based on both an output of the image pickup unit 11 for capturing an image of an object and an output of the range information obtaining unit 13 for receiving light projected to the object and reflected from the object; the display image further includes a three-dimensional image 3G determined by the three-dimensional reconstruction processing unit 650.

FIG. 22 is a diagram illustrating the display contents of the display unit according to the fifth to seventh variants.

As depicted in FIG. 22, a three-dimensional image 3G including identification information 3Ga, 3Gb, or 3Gc for identifying a specific object is displayed on the display unit 520 by the display control unit 530. 3Ga, 3Gb, and 3Gc may be position identification information identifying the positions of the specific objects.

In FIG. 22, the display unit 520 is depicted, but a three-dimensional image 3G including identification information 3Ga, 3Gb, or 3Gc for identifying a specific object is also displayed by the display control unit 170 on the display unit 20.

In FIG. 22, a blind spot is identified by the identification information 3Ga implemented by highlighting in pink or the like, a reflective object is identified by the identification information 3Gb implemented by highlighting in orange or the like, and a distant object is identified by the identification information 3Gc implemented by mosaic processing or the like.

All of these items of identification information 3Ga, 3Gb and 3Gc may be displayed at the same time, or any one or two of these items may be displayed at the same time.

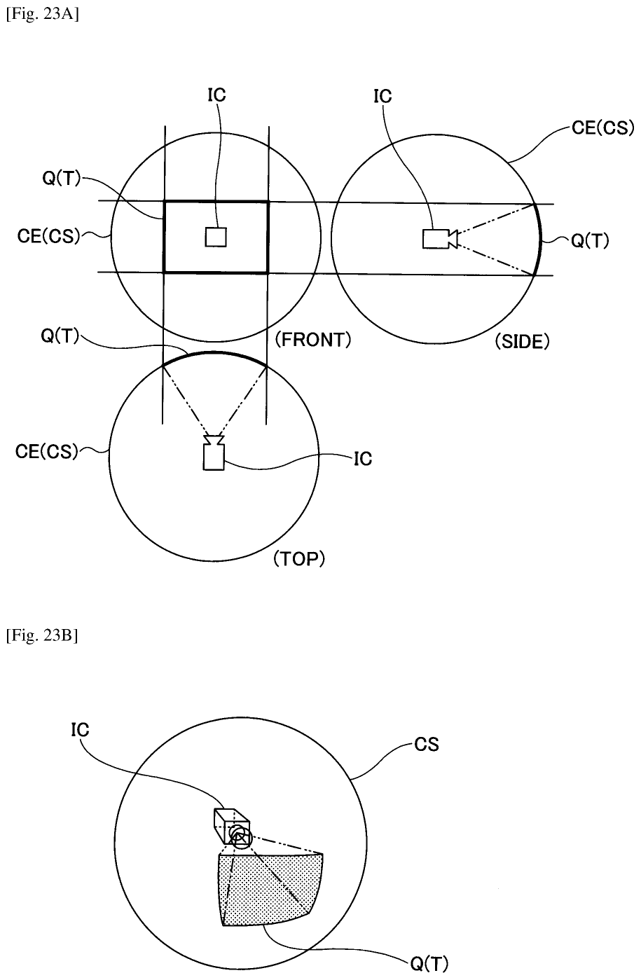

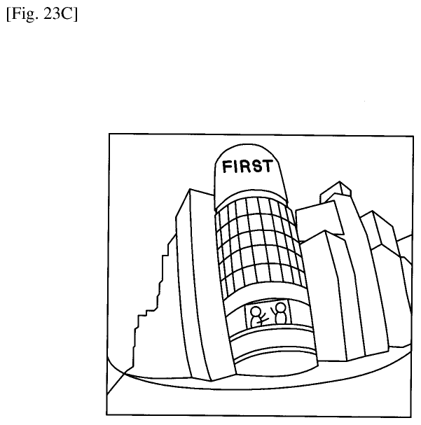

FIGS. 23A-23C illustrate three-dimensional images displayed on the display unit according to the embodiments (including the embodiment and variants of the embodiment) of the present invention.

FIG. 23A depicts a position of a virtual camera and a predetermined area when an omnidirectional image is expressed by a three-dimensional sphere. The virtual camera IC corresponds to a position of the point of view of the user viewing the image with respect to the omnidirectional image CE expressed as a three-dimensional sphere.

FIG. 23B is a three-dimensional perspective view of FIG. 23A, and FIG. 23C depicts an image of the predetermined area displayed on a display.

FIG. 23B depicts the omnidirectional image CE depicted in FIG. 23A expressed as the three-dimensional sphere CS. When the omnidirectional image CE is thus expressed as the three-dimensional sphere CS, the virtual camera IC is located inside the omnidirectional image CE, as depicted in FIG. 23A.

The predetermined area T in the omnidirectional image CE is the image pickup area of the virtual camera IC, and is specified by the predetermined area information including the image pickup direction and the angle of view of the virtual camera IC with respect to the three-dimensional virtual space including the omnidirectional image CE.

Zooming of the predetermined area T can be implemented by moving the virtual camera IC nearer to or away from the omnidirectional image CE. The predetermined area image Q is an image of the predetermined area T of the omnidirectional image CE. Therefore, the predetermined area T can be specified by the angle of view a and the distance f between the virtual camera IC and the omnidirectional image CE.

That is, the display control unit 170 or 530 can change the position and the orientation of the virtual camera IC that is at the point-of-view position from where the three-dimensional image 3G is viewed, thereby changing the display area of the three-dimensional image 3G to be displayed on the display unit 20 or 520.

Thus, the three-dimensional image displayed by the display unit has been described where an omnidirectional image is used as an example. The same applies to the case of using three-dimensional point cloud data. A three-dimensional point cloud is arranged in a virtual space and a virtual camera is arranged in the virtual space. A three-dimensional image is obtained by projecting a three-dimensional point cloud onto a predetermined projection plane in a virtual space based on predetermined area information indicating a point-of-view position, an image pickup direction, and an angle of view of the virtual camera. The point-of-view position and orientation of the virtual camera can be changed to change the display area of the three-dimensional image.

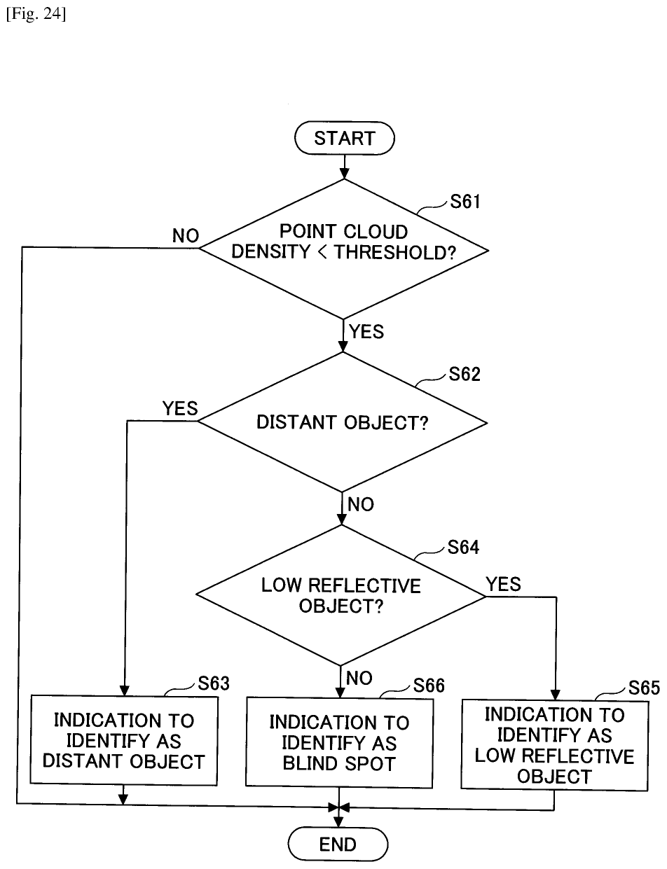

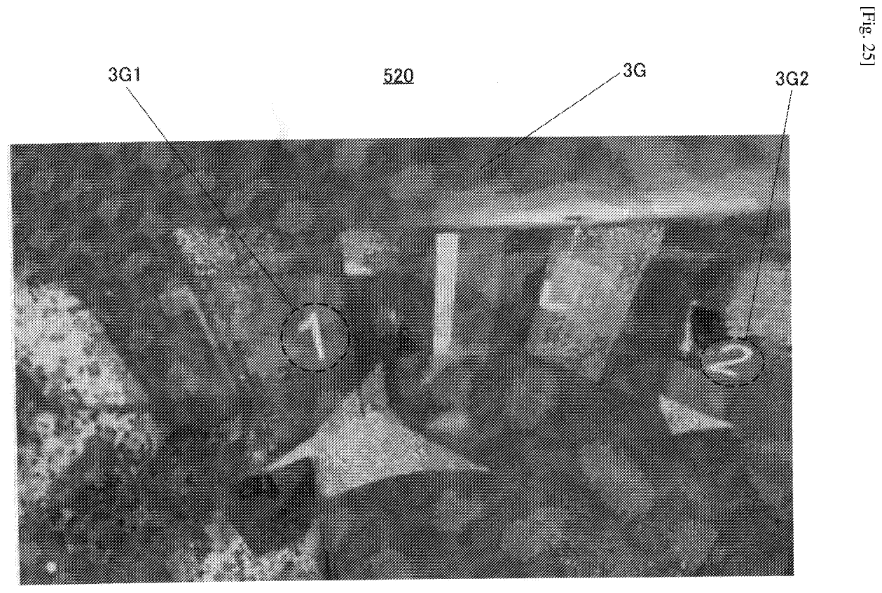

FIG. 24 is a determination flow diagram of the fifth to seventh variants. In Step S61, the determining unit 160, 560, or 660 determines whether there is an area (coordinates) in which the density with respect to point cloud data is less than a threshold in the omnidirectional three-dimensional data based on the omnidirectional three-dimensional data obtained from the three-dimensional reconstruction processing unit 150, 550, or 650.

In Step S62, when it is determined in Step S61 that there is an area (coordinates) in which the density with respect to the point cloud data is less than the threshold, the determining unit 160, 560, or 660 determines based on the output of the image pickup unit 11 according to the flow depicted in FIG. 16 whether a plurality of pixels having the same coordinates as the area in which the density with respect to the point cloud data is less than the threshold include a pixel that is determined to be a distant object. When a pixel that is determined to be a distant object is included, the coordinate position information of the pixel is output to the display control unit 170 or 530.

The display control unit 170 or 530 displays on the display unit 20 or 520 (Step S63) the display image including position identification information 3Gc for identifying the position of the distant object based on the coordinate position information of the pixel obtained from the determining unit 160, 560, or 660, and including the three-dimensional image G, as depicted in FIG. 22, and ends the process.

In Step S62, with regard to a plurality of pixels having the same coordinates as an area in which the density with respect to the point cloud data is less than the threshold, when a pixel determined to correspond to a distant object is not included, the determining unit 160, 560, or 660 determines whether a pixel determined to be a low reflective object is included based on the output of the image pickup unit 11 according to the flow depicted in FIG. 16. When a pixel determined to be a low reflective object is included, the coordinate position information of the pixel is output to the display control unit 170 or 530 in Step S64.

The display control unit 170 or 530 display the display image including position identification information 3Gb for identifying the position of the low reflective object based on the coordinate position information of the pixel obtained from the determining unit 160, 560, or 660, and including the three-dimensional image G on the display unit 20 or 520 (Step S65) as depicted in FIG. 22, and ends the process.

In Step S64, the determining unit 160, 560, or 660 determines that the plurality of pixels correspond to a blind spot when, in step S64, the plurality of pixels having the same coordinates as the area where the density with respect to the point cloud data is less than the threshold do not include a pixel determined to correspond to a low reflective object, and outputs the coordinate position information of the pixels to the display control unit 170 or 530.

The display control unit 170 or 530 displays the display images on the display unit 20 or 520 (Step S66) including position identification information 3Ga for identifying the position of the blind spot on the basis of the coordinate position information of the pixels obtained from the determining unit 160, 560, and 660 and including the three-dimensional images G as depicted in FIG. 22, and ends the process. Steps S61, S62, and S64 are examples of a determination step, and Steps S63, S65, and S66 are examples of a displaying step.

As described above, the image pickup apparatus 1 and the display apparatus 500 include the display control units 170 and 530 that cause the display units 20 and 520 to display the display images and perform displaying differently. The display images include: identification information 3Ga, 3Gb, or 3Gc that identifies a specific object based on the determination results of the determining units 160, 560, and 660 that determine whether a specific object exists based on both the output of the image pickup unit 11 that captures an image of an object and the output of the range information obtaining unit 13 that projects light to the object and receives light reflected from the object; and include three-dimensional images 3G that are determined based on the output of the range information obtaining unit 13 by the three-dimensional re-construction processing units 150, 550, and 650 that are examples of the three-dimensional information determining unit.

The specific object may be not only a distant object, a low reflective object, or a blind spot, but also an adjacent object, a high reflective object, or an image blur area.

This allows determining, by viewing the three-dimensional image 3G, which one of a distant object, a low reflective object, a blind spot, an adjacent object, a high reflective object, and an image blur causes the desired three-dimensional image 3G not to be displayed.

The image pickup apparatus 1 and the display apparatus 500 include the display control units 170 and 530 for displaying on the display units 20 and 520 the three-dimensional images 3G, which are determined based on the output of the range information obtaining unit 13 that projects light to an object and receives light reflected from the object. The display control units 170 and 530 display on the display units 20 and 520 the display images including (i) the position identification information 3Ga, 3Gb, or 3Gc for identifying the position of at least one of the distant object, the low reflective object, or the blind spot, based on the position information indicating the position of the at least one of the distant object distant from the range information obtaining unit 13 when the light reflected from the object is received, the low reflective object having low reflectance with respect to the projected light, or the blind spot with respect to the range information obtaining unit 13 when the light reflected from the object is received; and (ii) the three-dimensional images 3G.

This allows determining, by viewing the three-dimensional image 3G, which one of a distant object, a low reflective object, and a blind spot causes the desired three-dimensional image 3G not to be displayed. Therefore, it is possible to take measures, such as capturing an image again, appropriately depending on the cause.

The three-dimensional image 3G is determined by the three-dimensional reconstruction processing unit 150, 550, or 650, which is an example of a three-dimensional information determining unit.

The display control units 170 and 530 may display the display images each including position identification information of any one of 3Ga, 3Gb, and 3Gc and a three-dimensional image 3G on the display units 20 and 520 based on position information of any one of a distant object, a low reflective object, and a blind spot, and may display the display images each including position identification information of any two or all of 3Ga, 3Gb, and 3Gc and a three-dimensional image 3G on the display units 20 and 520 based on position information of any two or all of a distant object, a low reflective object, and a blind spot.

When the information processing apparatus is the image pickup apparatus 1, the image pickup apparatus 1 includes the range information obtaining unit 13 and the three-dimensional reconstruction processing unit 150 as depicted in FIG. 19.

When the information processing apparatus 500 is the display apparatus 500, as illustrated in FIGS. 20 and 21, the display apparatus 500 does not include the range information obtaining unit 13, and the image pickup apparatus 1 includes the range information obtaining unit 13 and transmits an output of the range information obtaining unit 13 to the display apparatus 500 or to the server 600.

The display apparatus 500 may include or need not include the three-dimensional re-construction processing unit 550 as depicted in FIG. 20.

When the display apparatus 500 does not include the three-dimensional reconstruction processing unit 550, the image pickup apparatus 1 may include the three-dimensional reconstruction processing unit 150 and transmit the three-dimensional image to the display apparatus 500, or the server 600 may include the three-dimensional reconstruction processing unit 650 and transmit the three-dimensional image to the display apparatus 500 as illustrated in FIG. 21.

The display control units 170 and 530 display on the display units 20 and 520 the display images including the position identification information 3Ga, 3Gb, and 3Gc based on position information indicating the position where it is determined that the density with respect to point cloud data included in the three-dimensional image 3G is lower than the threshold and at least one of a distant object, a low reflective object, or a blind spot is present, and including the three-dimensional images 3G.

Accordingly, it is possible to determine, by viewing the three-dimensional image 3G, whether the cause of the density with respect to the point cloud data being lower than the threshold is a distant object, a low reflective object, or a blind spot.

The display control units 170 and 530 display on the display units 20 and 520 the display images including the position identification information 3Ga, 3Gb, or 3Gc based on position information indicating a position determined to be at least one of a distant object, a low reflective object, or a blind spot in the three-dimensional image 3G based on the output of the image pickup unit 11 that captures an image of an object, and including the three-dimensional image 3G.

Accordingly, it is possible to accurately determine which of a distant object, a low reflective object, or a blind spot is the cause of the desired three-dimensional image 3G being not displayed based on the output of the image pickup unit 11.

When the information processing apparatus is the image pickup apparatus 1, the image pickup apparatus 1 includes the image pickup unit 11 as depicted in FIG. 19. When the information processing apparatus 500 is the display apparatus 500, the display apparatus 500 does not include the image pickup unit 11 as depicted in FIG. 20 and FIG. 21, and the image pickup apparatus 1 includes the image pickup unit 11 and transmits the output of the image pickup unit 11 to the display apparatus 500 or to the server 600.

The image pickup apparatus 1 and the display apparatus 500 include the determining units 160, 560, and 660 for determining the position of a distant object, a low reflective object, or a blind spot in the three-dimensional image 3G. The display control units 170 and 530 display the display images including position identification information 3Ga, 3Gb, or 3Gc based on the determination results of the determining units 160, 560, and 660, and the three-dimensional image 3G on the display units 20 and 520.

When the information processing apparatus is the image pickup apparatus 1, the image pickup apparatus 1 includes the determining unit 160 as depicted in FIG. 19.

When the information processing apparatus 500 is the display apparatus 500, the display apparatus 500 may include the determining unit 560 as illustrated in FIG. 20, or need not include the determining unit 560.

When the display apparatus 500 does not include the determining unit 560, the image pickup apparatus 1 may include the determining unit 160 to transmit the determination result to the display apparatus 500, or the server 600 may include the determining unit 660 as depicted in FIG. 21 to transmit the determination result to the display apparatus 500.

FIG. 25 is another view illustrating the display contents of the display unit according to the fifth to seventh variants.

As depicted in FIG. 25, by the display control unit 530, a three-dimensional image 3G including position identification information 3G1 and 3G2, for identifying the positions of the range information obtaining unit 13 obtained when the light reflected from the object is received by the range information obtaining unit 13, is displayed on the display unit 520.

The three-dimensional image 3G is determined based on the output of the range information obtaining unit 13 that is at the first position and the output of the range information obtaining unit 13 that is at the second position different from the first position. The position identification information 3G1 is an example of the first position identification information that identifies the first position, and the position identification information 3G2 is an example of the second position identification information that identifies the second position.

In FIG. 25, the display unit 520 is depicted, but the three-dimensional image 3G including the position identification information 3G1 and 3G2 for identifying the positions of the range information obtaining unit 13 obtained when the light reflected from the object is received is also displayed on the display unit 20 by the display control unit 170.

As depicted in FIG. 22, the display control unit 170 or 530 displays the display image including the three-dimensional image 3G and the identification information 3Ga, 3Gb, or 3Gc, which are examples of low density identification information, on the display unit 20 or 520. At the same time, as depicted in FIG. 25, the position identification information 3G1 and 3G2 for identifying the positions of the range information obtaining unit 13 obtained when the light reflected from the object is received may be included in the display image.

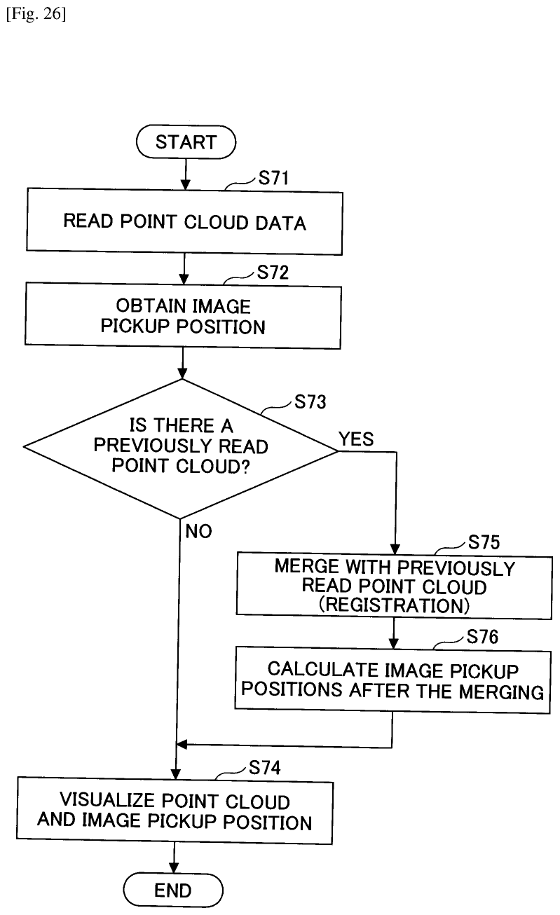

FIG. 26 is a flow diagram illustrating processing in the fifth to seventh variants.

In Step S71, the three-dimensional reconstruction processing unit 150, 550, or 650 reads the omnidirectional high-density three-dimensional point cloud data, and, in step S72, obtains the origin with respect to the three-dimensional point cloud data as position information indicating the image pickup position of the range information obtaining unit 13 obtained when the range information obtaining unit receives light reflected from the object.

In Step S73, the three-dimensional reconstruction processing unit 150, 550, or 650 determines whether there is previously read three-dimensional point cloud data. If there is no previously read three-dimensional point cloud data, the three-dimensional point cloud data read in Step S71 and the position information obtained in Step S72 are output to the display control unit 170 or 530.

The display control unit 170 or 530 displays the display image on the display unit 20 or 520 (Step S74) including the position identification information 3G1 for identifying the position of the range information obtaining unit 13 obtained when the range information obtaining unit 13 receives the light reflected from the object and the three-dimensional image 3G, based on the three-dimensional point cloud data and position information obtained from the three-dimensional reconstruction processing unit 150, 550, or 650, as depicted in FIG. 25, and ends the process.

In Step S75, the three-dimensional reconstruction processing unit 150, 550, or 650 merges the three-dimensional point cloud data read in Step S71 with previously read three-dimensional point cloud data, if there is the previously read three-dimensional point cloud data in Step S73.

In Step S76, the three-dimensional reconstruction processing unit 150, 550, or 650 calculates, for each of the origin with respect to the three-dimensional point cloud data read in Step S71 and the origin with respect to the previously read three-dimensional point cloud data, the coordinates with respect to the three-dimensional point cloud data merged in Step S75 as the position information of the corresponding image pickup position, and outputs the three-dimensional point cloud data merged in Step S75 and the calculated information indicating the plurality of origins to the display control unit 170 or 530.

In Step S74, the display control unit 170 or 530 displays on the display unit 20 or 520, as depicted in FIG. 25, the display image including the plurality of sets of position identification information 3G1 and 3G2 for identifying the positions of the range information obtaining unit 13 obtained when the range information obtaining unit 13 receives the light reflected from the object, and a three-dimensional image 3G, based on the three-dimensional point cloud data and the plurality of sets of position information obtained from the three-dimensional reconstruction processing unit 150, 550, or 650.

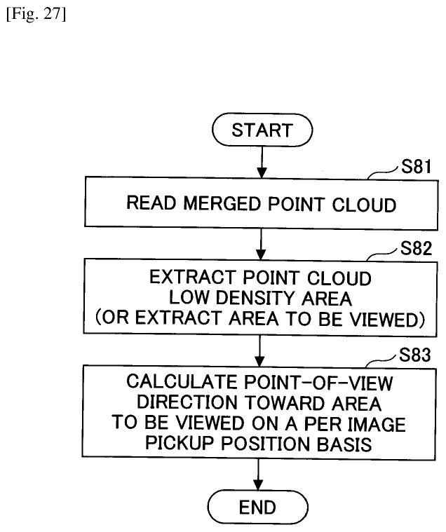

FIG. 27 is another flow diagram illustrating processing in the fifth to seventh variants.

In Step S81, the three-dimensional reconstruction processing unit 150, 550, or 650 reads the omnidirectional high density three-dimensional point cloud data. In Step S82, the determining unit 160, 560, or 660s performs the Steps S61, S62, and S64 of the flow depicted in FIG. 24 based on the omnidirectional three-dimensional data obtained from the three-dimensional reconstruction processing unit 150, 550, or 650 to extract the low density portion where the density with respect to the point cloud data is lower than the threshold.

When the virtual camera IC depicted in FIGS. 23A-23C is at the position of the position identification information 3G1 or 3G2 depicted in FIG. 25, the display control unit 170 or 530 executes Steps S63, S65, and S66 of the flow depicted in FIG. 24 to change the orientation of the virtual camera IC so that the identification information of at least one of 3Ga, 3Gb, or 3Gc, which are examples of low density identification information depicted in FIG. 22, is included in the display image (Step S83). As described above, the image pickup apparatus 1 and the display apparatus 500

include the display control units 170 and 530 for displaying the three-dimensional images 3G determined based on the output of the range information obtaining unit 13 on the display units 20 and 520. Based on position information indicating positions of the range information obtaining unit 13 obtained when light reflected from an object is received by the range information obtaining unit 13, the display control units 170 and 530 display, on the display units 20 and 520, the display images including the position identification information 3G1 and 3G2 for identifying the positions of the range information obtaining unit 13 obtained when the light reflected from the object is received by the range information obtaining unit 13, and including the three-dimensional images 3G.

Accordingly, positional relationships between the image pickup positions indicating the positions of the range information obtaining unit 13 obtained when the light reflected from the object is received by the range information obtaining unit 13 and the position of the specific object can be understood from the three-dimensional image 3G.

The three-dimensional image 3G and position information are determined by the three-dimensional reconstruction processing units 150, 550, and 650.

When the information processing apparatus is the image pickup apparatus 1, the image pickup apparatus 1 includes the range information obtaining unit 13 and the three-dimensional reconstruction processing unit 150 as depicted in FIG. 19.

When the information processing apparatus 500 is the display apparatus 500, as illustrated in FIGS. 20 and 21, the display apparatus 500 does not include the range information obtaining unit 13, and the image pickup apparatus 1 includes the range information obtaining unit 13 and transmits an output of the range information obtaining unit 13 to the display apparatus 500 or to the server 600.

The display apparatus 500 may include the three-dimensional reconstruction processing unit 550, as depicted in FIG. 20, or need not include the three-dimensional reconstruction processing unit 550.

When the display apparatus 500 does not include the three-dimensional reconstruction processing unit 550, the image pickup apparatus 1 may include the three-dimensional reconstruction processing unit 150 and transmit three-dimensional image and position information to the display apparatus 500, or the server 600 may include the three-dimensional reconstruction processing unit 650, as depicted in FIG. 21, and transmit three-dimensional image and position information to the display apparatus 500.

The display control units 170 and 530 display on the display units 20 and 520 the display images including the identification information 3Ga, 3Gb, or 3Gc, which is an example of the low-density identification information for identifying an area, based on area information indicating the area in which the density with respect to the point cloud data is lower than the threshold with respect to the three-dimensional image 3G, and including the three-dimensional image 3G.

In this case, because the positional relationships between the image pickup position and the area where the density with respect to the point cloud data is lower than the threshold can be understood, it is possible to identify the cause of the density with respect to the point cloud data being lower than the threshold. For example, it can be determined that a distant object is the cause when the area is distant from the image pickup position, a blind spot is the cause when the area is at a blind spot with respect to the image pickup position, or a low reflective object is the cause when the area is not at a distance and not at a blind spot.

The display control units 170 and 530 change the position and orientation of the virtual camera IC that is at the point-of-view position from where the three-dimensional image 3G is viewed, thereby changing the display areas of the three-dimensional images 3G to be displayed on the display units 20 and 520.

The display control units 170 and 530 change the orientation of the virtual camera IC to a predetermined orientation when the position of the virtual camera IC is at the position 3G1 or 3G2 identified by the position identification information. The predetermined orientation is such that the display area should include a position that is the cause of taking an image again, such as a low-density point cloud area, a position that meets predetermined conditions, such as a position previously set to be checked for an onsite investigation, or any position at which the person who takes the image or other person who performs a checking work wishes to perform checking. Specific examples of the position previously set to be checked for an onsite investigation include: a location where changes are continuously occurring at the site (material stockyard), the location of each component of a building, spaces between the components, spaces for new installations, temporary installations (a stockyard, and a scaffolding, etc., which are used during a construction process and removed thereafter), a storage space for heavy machinery (a forklift, a crane, etc.), a work space (the range of rotation of a machine arm, a material moving route, etc.), and a movement route for residents (a bypass route during construction), and so forth.

This allows the line of sight of the user who is at the image pickup position to be directed to a specific object that is desired to be viewed at the site.

The display control units 170 and 530 change the orientation of the virtual camera IC so that the display area includes previously set coordinates or a low density portion in which the density with respect to the point cloud data is lower than the threshold with respect to the three-dimensional image 3G. The previously set coordinates do not identify an image, and are maintained even when, for example, an image at predetermined coordinates changes before and after the merging the three-dimensional point cloud data in Step S75 of FIG. 26.

This allows the line of sight of the user who is at the image pickup position to be directed to a specific object corresponding to a low density portion in the 3G three-dimensional image.

The display control units 170 and 530 display the three-dimensional images 3G determined based on the output of the range information obtaining unit 13 located at the first position and the output of the range information obtaining unit 13 located at the second position different from the first position; and the display units 20 and 520 display, on the display units 20 and 520, the display images including the first position identification information 3G1 for identifying the first position and the second position identification information 3G2 for identifying the second position, and the three-dimensional image 3G.

Thus, the positional relationships between the first and second image pickup positions and the specific object can be understood from the three-dimensional image 3G.

### Summary of Embodiments

As described above, the image pickup apparatus 1 according to the embodiments of the present invention includes the image pickup unit 11 for capturing an image of an object, the projection unit 12 for projecting light onto the object, the range information obtaining unit 13 for receiving light reflected from the object (an example of a light receiving unit), the determining unit 160 for determining whether a high reflective object is present on the basis of both the output of the range information obtaining unit 13 and the output of the image pickup unit 11, and the display control unit 170 for causing the display unit 20 or 520 to perform displaying differently depending on presence or absence of a high reflective object.

This allows the person who takes the image to accurately find that a high reflective object, such as a minor, is included in the taken image, distinguishing the object from an effect of an adjacent object or external light.

The image pickup apparatus 1 includes the display unit 20. This allows the person who takes the image to surely find that a high reflective object is included in the taken image.

The display control unit 170 causes the display unit 20 or 520 perform displaying differently at a position of the display unit 20 or 520 corresponding to the position of a high reflective object. This allows the person who takes the image to identify the position of the high reflective object.

The display unit 20 includes the plurality of display units 20A and 20a, and the display control unit 170 causes the display unit from among the plurality of display units 20A and 20a nearer to a high reflective object to perform displaying differently depending on presence or absence of the object. This allows the person who takes the image to surely identify the position of the high reflective object.

The display control unit 170 displays the image information G captured by the image pickup unit 11 on the display unit 20 or 520 and displays the display image including identification information for identifying a high reflective object and image information G on the display unit 20 or 520. This allows the person who takes the image to surely identify the position of the high reflective object.

The determining unit 160 determines that there is a high reflective object when the charge stored amount is saturated as an example of a pixel in which the charge stored amount of the pixel is more than or equal to a predetermined value due to the light received by the range information obtaining unit 13 and the image information captured by the image pickup unit is coincident with the model image information as an example of the reference information indicating a high reflective object.

This allows the person who takes the image to accurately determine that a high reflective object appears in the taken image, distinguishing the object from an effect of an adjacent object or external light.

The image pickup apparatus 1 obtains range information with respect to an object based on the light received by the range information obtaining unit 13. In this case, the person who takes the image can determine that the cause of not being able to obtain the desired range information is not an adjacent object or an external light but a high reflective object.

The image pickup apparatus 1 includes the transmitting and receiving unit 180 as an example of an output unit that outputs three-dimensional information determined based on range information obtained from the range information obtaining unit 13. In this case, the person who takes the image can determine that the cause of not being able to obtain the desired three-dimensional information is a high reflective object, not an adjacent object or external light.

The image processing method according to the embodiments of the present invention includes: an image pickup step of capturing an image of an object by the image pickup unit 11; a projection step of projecting light to the object by the projection unit 12; a light receiving step of receiving light reflected from the object by the range information obtaining unit 13; a determining step of determining by the determining unit 160, 560, or 660 whether there is a high reflective object on the basis of both the output of the range information obtaining unit 13 and the output of the image pickup unit 11; and a displaying step of causing the display control units 170 and 530 to perform displaying differently depending on presence or absence of the high reflective object.

The image pickup apparatus 1 and the display apparatus 500 as examples of an information processing apparatus according to the embodiments of the present invention are provided with the display control units 170 and 530 that cause the display units 20 and 520 to perform displaying differently depending on presence or absence of a high reflective object based on the determination results of the determining units 160, 560, and 660 that determine whether a high reflective object is present based on both the output of the image pickup unit 11 that captures an image of an object and the output of the range information obtaining unit 13 that projects light onto the object and receives light reflected from the object.

The display apparatus 500, which is an example of an information processing device according to the embodiments of the present invention, includes the transmitting and receiving unit 510 as an example of a receiving unit that receives a determination result from the determining unit 160 of the image pickup apparatus 1 or from the determining unit 660 of the server 600 determining whether there is a specific object based on both an output of the image pickup unit 11 that captures an image of an object and an output of the range information obtaining unit 13 that projects light and receives light reflected from the object, and the display control unit 530 that causes the display unit 520 to perform displaying differently depending on presence or absence of the specific object based on the determination result received by the transmitting and receiving unit 510. The specific object may be an adjacent object, a high reflective object, a distant object, a low reflective object, a blind spot, or an image blur area.

The display apparatus 500, which is an example of an information processing apparatus according to the embodiments of the present invention, includes the transmitting and receiving unit 510 as an example of a receiving unit which receives an output of the image pickup unit 11 capturing an object and an output of the range information obtaining unit 13 receiving light projected to the object and reflected from the object, the determining unit 560 for determining whether a specific object exists on the basis of both the output of the range information obtaining unit 13 and the output of the image pickup unit 11 received by the transmitting and receiving unit 510, and the display control unit 530 causing the display unit to perform displaying differently depending on presence or absence of the specific object based on the determination result of the determining unit 560. The specific object may be an adjacent object, a high reflective object, a distant object, a low reflective object, a blind spot, or an image blur area.

The image pickup apparatus 1 and the display apparatus 500, as examples of an information processing apparatus according to the embodiments of the present invention, include the display control units 170 and 530 for displaying display images on the display units 20 and 520, including identification information 3Ga, 3Gb, or 3Gc for identifying a specific object based on the determination results of the determining units 160 and 560 for determining whether the specific object is present based on both the output of the image pickup unit 11 for capturing an image of an object and the output of the range information obtaining unit 13 for receiving light projected to the object and reflected from the object, and including the three-dimensional image 3G. The specific object may be not only a distant object, a low reflective object, or a blind spot, but also an adjacent object, a high reflective object, or an image blur area.

The three-dimensional image 3G is determined by the three-dimensional reconstruction processing unit 150, 550, or 650, which is an example of a three-dimensional information determining unit, based on the output of the range information obtaining unit 13.

This allows determining which of a distant object, a low reflective object, a blind spot, an adjacent object, a high reflective object, and an image blur is the cause of the desired three-dimensional image 3G not being able to be displayed, by viewing the three-dimensional image 3G.

The image pickup apparatus 1 and the display apparatus 500, as examples of an information processing apparatus according to the embodiments of the present invention, include the display control units 170 and 530 for displaying display images on the display units 20 and 520 including position identification information for identifying a position based on position information indicating a position for which the determining units 160 and 560 determine whether the output of the range information obtaining unit 13 for receiving light projected to the object and reflected from the object is more than or equal to a threshold or is less than or equal to a threshold, and including two-dimensional image information G captured by the image pickup unit 11 for capturing an image of an object.

Therefore, by identifying from the two-dimensional image G the position for which the output of the range information obtaining unit 13 is more than or equal to a threshold or is less than or equal to a threshold, that is, the position for which the output of the range information obtaining unit 13 is too strong or too weak to obtain the desired output, it is possible to determine the cause of the desired output being not able to be obtained.

The image pickup apparatus 1 and the display apparatus 500, as examples of an information processing apparatus according to the embodiments of the present invention, include the display control units 170 and 530 for, based on position information indicating a position for which the determining units 160 and 560 determine that it is not possible to obtain range information with respect to an object based on an output of the range information obtaining unit 13 for receiving light projected to the object and reflected from the object, displaying display images on the display units 20 and 520 including position identification information for identifying the position and two-dimensional image information G captured by the image pickup unit 11 for capturing an image of the object.

Therefore, by identifying from the two-dimensional image G the position for which the range information with respect to the object cannot be obtained, it is possible to find the cause of the range information with respect to the object being not able to be obtained.

The determining unit 160, 560, or 660 determines that range information with respect to the object cannot be obtained not only when the output of the range information obtaining unit 13 is more than or equal to a threshold or less than or equal to a threshold but also when an image blur is detected from the output of the range information obtaining unit 13.

As described above, when the information processing apparatus is the image pickup apparatus 1, the image pickup apparatus 1 includes the image pickup unit 11, the range information obtaining unit 13, the three-dimensional reconstruction processing unit 150, and the determining unit 160 as illustrated in FIG. 19.

When the information processing apparatus 500 is the display apparatus 500, the display apparatus 500 does not include the image pickup unit 11 and the range information obtaining unit 13, and the image pickup apparatus 1 includes the image pickup unit 11 and the range information obtaining unit 13, as illustrated in FIGS. 20 and 21, and transmits the outputs of these units to the display apparatus 500 or to the server 600.

The display apparatus 500 may include, as depicted in FIG. 20, or need not include the determining unit 560.

When the display apparatus 500 does not include the determining unit 560, the image pickup apparatus 1 may include the determining unit 160 to transmit the determination result to the display apparatus 500, or the server 600 may include the determining unit 660 as depicted in FIG. 21 to transmit the determination result to the display apparatus 500.

Similarly, the display apparatus 500 may include the three-dimensional reconstruction processing unit 550 as depicted in FIG. 20 or need not include the three-dimensional reconstruction processing unit 550.

When the display apparatus 500 does not include the three-dimensional reconstruction processing unit 550, the image pickup apparatus 1 may include the three-dimensional reconstruction processing unit 150 and transmit the three-dimensional image to the display apparatus 500, or the server 600 may include the three-dimensional reconstruction processing unit 650 and transmit the three-dimensional image to the display apparatus 500 as illustrated in FIG. 21.

As described above, the image pickup apparatus 1 according to the embodiments of the present invention includes the image pickup unit 11 for capturing an image of an object, the projection unit 12 for projecting light onto the object, the range information obtaining unit 13 for receiving light reflected from the object (an example of a light receiving unit), the determining unit 160 for determining whether a distant object or a low reflective object exists on the basis of both the output of the range information obtaining unit 13 and the output of the image pickup unit 11, and the display control unit 170 for causing the display unit 20 or 520 to perform displaying differently depending on presence or absence of the distant object or low reflective object.

This allows the person who takes the image to accurately determine that a distant object or a low reflective object, such as a black object, appears in the taken image.

The image pickup apparatus 1 includes the display unit 20. This ensures that the person who takes the image will find that a distant object or a low reflective object appears in the taken image.

The display control unit 170 causes the display unit 20 or 520 to perform displaying differently at a position of the display unit 20 or 520 corresponding to the position of the distant object or the low reflective object. This allows the person who takes the image to identify the position of the distant object or the low reflective object.

The display unit 20 includes the plurality of display units 20A and 20a, and the display control unit 170 causes the display unit of the plurality of display units 20A and 20a nearer to a distant object or a low reflective object to perform displaying differently depending on presence or absence of the object. This allows the person who takes the image to surely identify the position of the distant object or the low reflective object.

The display control unit 170 displays the image information G captured by the image pickup unit 11 on the display unit 20 or 520 and displays the display image on the display unit 20 or 520 including identification information for identifying a distant object or a low reflective object, and image information G. This allows the person who takes the image to surely identify the position of the distant object or the low reflective object.

When the charge stored amount with respect to a pixel due to light received by the range information obtaining unit 13 is less than or equal to a threshold, the determining unit 160 determines whether it is a low reflective object or a distant object based on the output of the image pickup unit 11. This allows the person who takes the image to accurately find that a low reflective object or a distant object appears in the taken image. When the charge stored amount with respect to a pixel due to light received by the range information obtaining unit 13 is less than or equal to a threshold and the charge stored amount with respect to the pixel of the image pickup unit 11 is less than or equal to a threshold, the determining unit 160 determines that there is a low reflective object. This allows the person who takes the image to accurately find that a low reflective object appears in the taken image.

The determining unit 160 determines that there is a distant object, when the charge stored amount with respect to a pixel due to light received by the range information obtaining unit 13 is less than or equal to a threshold, the charge stored amount with respect to the pixel of the image pickup unit 11 is more than or equal to a threshold, and the distance determined based on the pixel is more than or equal to a threshold.

This allows the person who takes the image to accurately find that a distant object appears in the taken image.

The image pickup apparatus 1 obtains range information with respect to an object based on the light received by the range information obtaining unit 13. In this case, the person who takes the image can identify the cause of not being able to obtain the desired range information is a distant object or a low reflective object.

The image pickup apparatus 1 includes the transmitting and receiving unit 180 as an example of an output unit that outputs three-dimensional information determined based on range information obtained from the range information obtaining unit 13. In this case, the person who takes the image can identify the cause of not being able to obtain the desired three-dimensional information is a distant object or a low reflective object.

The image processing method according to the embodiments of the present invention includes: an image pickup step of capturing an image of an object by the image pickup unit 11; a projection step of projecting light to the object by the projection unit 12; a light receiving step of receiving light reflected from the object by the range information obtaining unit 13; a determination step of determining whether there is a distant object or a low reflective object by the determining unit 160, 560, or 660 based on both the output of the range information obtaining unit 13 and the output of the image pickup unit 11; and a display step of causing the display unit 20 or 520 to perform displaying differently depending on presence or absence of a distant object or a low-reflective object by the display control unit 170 or 530.

The image pickup apparatus 1 and the display apparatus 500 as examples of an information processing apparatus according to the embodiments of the present invention include display control units 170 and 530 that cause the display units 20 and 520 to perform displaying differently depending on presence or absence of a distant object or a low reflective object based on the determination result of determining by the determining units 160, 560, and 660 whether a distant object or a low reflective object is present based on both the output of the image pickup unit 11 that captures an image of the object and the output of the range information obtaining unit 13 that projects light and receives light reflected from the object.

As described above, the image pickup apparatus 1 according to the embodiments of the present invention includes the image pickup unit 11 for capturing an image of an object, the projection unit 12 for projecting light onto the object, the range information obtaining unit 13 for receiving light reflected from the object (an example of a light receiving unit), a determining unit 160 for determining whether an image blur occurs on the basis of both the output of the range information obtaining unit 13 and the output of the image pickup unit 11, and the display control unit 170 for causing the display unit 20 or 520 to perform displaying differently depending on whether an image blur occurs.

This allows the person who takes the image to accurately find that an image blur appears in the taken image.

The image pickup apparatus 1 includes the display unit 20. This allows the person who takes an image to find that an image blur appears in the taken image.

The display control unit 170 causes the display unit 20 or 520 to perform displaying differently at a position of the display unit 20 or 520 corresponding to the position of an image blur. This allows the person who takes the image to identify the position of the image blur.

The display unit 20 includes the plurality of display units 20A and 20a, and the display control unit 170 causes the display unit of the plurality of display units 20A and 20a nearer to the position of an image blur to perform displaying differently depending on presence or absence of an image blur. This allows the person who takes the image to surely identify the position of the image blur.

The display control unit 170 displays the image information G captured by the image pickup unit 11 on the display unit 20 or 520 and displays a display image including identification information for identifying an image blur and the image information G on the display unit 20 or 520. This allows the person who takes the image to surely identify the position of the image blur.

The determining unit 160 determines that there is an image blur when an edge of an image is detected based on the image information captured by the image pickup unit 11 and a pixel with respect to light received by the range information obtaining unit 13 is shifted.

This allows the person who takes the image to accurately find that an image blur appears in the taken image.

The image pickup apparatus 1 obtains range information with respect to an object based on the light received by the range information obtaining unit 13. In this case, the person who takes the image can understand that the cause of not being able to obtain the desired range information is an image blur.

The image pickup apparatus 1 includes the transmitting and receiving unit 180 as an example of an output unit that outputs three-dimensional information determined based on range information obtained from the range information obtaining unit 13. In this case, the person who takes the image can identify the cause of not being able to obtain the desired three-dimensional information as an image blur.

The image processing method according to the embodiments of the present invention includes: an image pickup step of capturing an image of an object by the image pickup unit 11; a projection step of projecting light to the object by the projection unit 12; a light receiving step of receiving light reflected from the object by the range information obtaining unit 13; a determination step of determining whether an image blur occurs on the basis of both the output of the range information obtaining unit 13 and the output of the image pickup unit 11 by the determining unit 160, 560, or 660; and a display step of causing the display unit 20 or 520 to perform displaying differently by the display control unit 170 or 530 depending on whether an image blur occurs.

The image pickup apparatus 1 and the display apparatus 500 as examples of an information processing apparatus according to the embodiments of the present invention include the display control units 170 and 530 for causing the display units 20 and 520 to perform displaying differently depending on presence or absence of an image blur based on the determination results of the determining units 160, 560, and 660, which determine whether there is an image blur on the basis of both the output of the image pickup unit 11 for capturing an image of an object and the output of the range information obtaining unit 13 for receiving light having been projected to the object and reflected from the object.

The image pickup apparatus 1 and the display apparatus 500 as examples of an information processing apparatus according to the embodiments of the present invention include the display control units 170 and 530 for displaying a three-dimensional image 3G determined based on an output of the range information obtaining unit 13 as an example of a light receiving unit that receives light projected to and reflected from the object. The display control units 170 and 530 display on the display units 20 and 520 the display images including (i) position identification information 3Ga, 3Gb, or 3Gc for identifying a position of at least one of a distant object, a low reflective object, or a blind spot in the three-dimensional image 3G determined to be a position of at least one of a distant object that is distant from the range information obtaining unit 13 when the light reflected from the object is received, a low reflective object having low reflectance with respect to the projected light, or a blind spot with respect to the range information obtaining unit 13 when the range information obtaining unit 13 receives light reflected from the object; and (ii) the three-dimensional image 3G.

Therefore, because it is thus possible to identify the cause of not being able to obtain the desired three-dimensional image 3G as being a distant object, a low reflective object, or a blind spot by viewing the three-dimensional image 3G, it is possible to take necessary measures such as taking an image again depending on the cause.

The three-dimensional image 3G is determined by the three-dimensional reconstruction processing units 150, 550, and 650, which are examples of a three-dimensional information determining unit.

The display control unit 170 or 530 may display a display image including position identification information of any one of 3Ga, 3Gb, and 3Gc based on position information of any one of a distant object, a low reflective object, and a blind spot and including a three-dimensional image 3G on the display unit 20 or 520, and may display a display image including position identification information of any two or all of 3Ga, 3Gb, and 3Gc based on position information of any two or all of a distant object, a low reflective object, and a blind spot and including a three-dimensional image 3G on the display unit 20 or 520.

When the information processing apparatus is the image pickup apparatus 1, the image pickup apparatus 1 includes the range information obtaining unit 13 and the three-dimensional reconstruction processing unit 150 as depicted in FIG. 19.

When the information processing apparatus 500 is the display apparatus 500, as illustrated in FIGS. 20 and 21, the display apparatus 500 does not include the range information obtaining unit 13, and the image pickup apparatus 1 includes the range information obtaining unit 13 and transmits an output of the range information obtaining unit 13 to the display apparatus 500 or to the server 600.

The display apparatus 500 may include the three-dimensional reconstruction processing unit 550 or need not include the three-dimensional reconstruction processing unit 550. When the display apparatus 500 does not include the three-dimensional reconstruction processing unit 550, the image pickup apparatus 1 may include the three-dimensional reconstruction processing unit 150 and transmit a three-dimensional image to the display apparatus 500, or, as depicted in FIG. 21, the server 600 may include the three-dimensional reconstruction processing unit 650 and transmit a three-dimensional image to the display apparatus 500.

The display control unit 170 or 530 displays on the display unit 20 or 520 a display image including (i) the position identification information 3Ga, 3Gb, or 3Gc based on position information indicating a position that is a position where the density with respect to point cloud data included in the three-dimensional image 3G is lower than a threshold and is determined to correspond to at least one of a distant object, a low-reflective object, or a blind spot, and (ii) the three-dimensional image 3G.

Accordingly, it is possible to identify the cause of the density with respect to the point cloud data being lower than a threshold as a distant object, a low reflective object, or a blind spot by viewing the three-dimensional image 3G.

The display control unit 170 or 530 displays on the display unit 20 or 520 a display image including (i) the position identification information 3Ga, 3Gb, or 3Gc based on the position information indicating a position determined to be at least one of a distant object, a low-reflective object, or a blind spot in the three-dimensional image 3G based on the output of the image pickup unit 11 for capturing an image of an object, and (ii) the three-dimensional image 3G.

Accordingly, it is possible to accurately identify the cause of the desired three-dimensional image 3G being not displayed based on the output of the image pickup unit 11 as a distant object, a low reflective object, or a blind spot.

When the information processing apparatus is the image pickup apparatus 1, the image pickup apparatus 1 includes the image pickup unit 11 as depicted in FIG. 19. When the information processing apparatus 500 is the display apparatus 500, the display apparatus 500 does not include the image pickup unit 11 as depicted in FIG. 20 and FIG. 21, and the image pickup apparatus 1 includes the image pickup unit 11 and transmits the output of the image pickup unit 11 to the display apparatus 500 or to the server 600.

The image pickup apparatus 1 and the display apparatus 500 include the determining units 160 and 560 for determining the position of at least one of a distant object, a low reflective object, or a blind spot in the three-dimensional image 3G; and the display control units 170 and 530 display the display images on the display units 20 and 520 including (i) the position identification information 3Ga, 3Gb, or 3Gc based on the determination results of the determining units 160 and 560, and (ii) the three-dimensional images 3G.

When the information processing apparatus is the image pickup apparatus 1, the image pickup apparatus 1 includes the determining unit 160 as depicted in FIG. 19. When the information processing apparatus 500 is the display apparatus 500, the display apparatus 500 may include the determining unit 560 as illustrated in FIG. 20 or need not include the determining unit 560.

When the display apparatus 500 does not include the determining unit 560, the image pickup apparatus 1 may include the determining unit 160 and transmit the determination result to the display apparatus 500, or the server 600 may include the determining unit 660 as depicted in FIG. 21 and transmit the determination result to the display apparatus 500.

The display control unit 170 or 530 changes the position and orientation of the virtual camera IC that is at the point-of-view position from where the three-dimensional image 3G is viewed, thereby changing the display area of the three-dimensional image 3G to be displayed on the display unit 20 or 520.

The image pickup apparatus 1 and the display apparatus 500 as examples of an information processing apparatus according to the embodiments of the present invention include the display control units 170 and 530 for displaying on the display units 20 and 520 three-dimensional images 3G determined based on an output of the range information obtaining unit 13 as an example of a light receiving unit that receives light projected to and reflected by the object; and the display control units 170 and 530 display the display images on the display units 20 and 520 including (i) position identification information 3G1 and 3G2 for identifying positions of the range information obtaining unit 13 obtained when the range information obtaining unit 13 receives light reflected from the object based on position information indicating the positions of the range information obtaining unit 13 obtained when the range information obtaining unit 13 receives light reflected from the object, and (ii) three-dimensional images 3G.

Accordingly, the image pickup positions indicating the positions of the range information obtaining unit 13 obtained when the range information obtaining unit 13 receives the light reflected from the object, and the positional relationships with respect to the specific object can be understood from the three-dimensional image 3G. That is, it is easy to compare the positional relationships between the image pickup positions and the specific object at the place where the three-dimensional image has been captured and the positional relationships between the image pickup positions and the specific object with respect to the three-dimensional image.

The three-dimensional image 3G and the position information are determined by the three-dimensional reconstruction processing units 150, 550, and 650, which are examples of the three-dimensional information determining unit.

When the information processing apparatus is the image pickup apparatus 1, the image pickup apparatus 1 includes the range information obtaining unit 13 and the three-dimensional reconstruction processing unit 150.

When the information processing apparatus 500 is the display apparatus 500, the display apparatus 500 does not include the range information obtaining unit 13, and the image pickup apparatus 1 includes the range information obtaining unit 13 and transmits the output of the range information obtaining unit 13 to the display apparatus 500 or to the server 600.

The display apparatus 500 may include the three-dimensional reconstruction processing unit 550 or need not include the three-dimensional reconstruction processing unit 550, and when the display apparatus 500 does not include the three-dimensional reconstruction processing unit 550, the image pickup apparatus 1 may include the three-dimensional reconstruction processing unit 150 and transmit a three-dimensional image and position information to the display apparatus 500, or the server 600 may include the three-dimensional reconstruction processing unit 650 and transmit a three-dimensional image and position information to the display apparatus 500. The display control unit 170 or 530 displays on the display unit 20 or 520 a display

image including (i) the identification information 3Ga, 3Gb, or 3Gc, which is an example of low-density identification information for identifying an area, based on area information indicating the area in which the density with respect to the point cloud data with respect to the three-dimensional image 3G is lower than a threshold, and (ii) the three-dimensional image 3G.

In this case, because the positional relationships between the image pickup position and the area where the density with respect to the point cloud data is lower than the threshold can be understood, it is possible to identify the cause of the density with respect to the point cloud data being lower than the threshold. For example, it can be found that a distant object is the cause when the area is more distant than the image pickup position, a blind spot is the cause when the area is at a blind spot with respect to the image pickup position, and a low reflective object is the cause when the area corresponds to neither a distant object nor a blind spot.

The display control unit 170 or 530 changes the position and orientation of the virtual camera IC that is at the point-of-view position from where the three-dimensional image 3G is viewed, thereby changing the display area of the three-dimensional image 3G to be displayed on the display unit 20 or 520.

The display control unit 170 or 530 changes the orientation of the virtual camera IC to a predetermined orientation when the position of the virtual camera IC is at a position 3G1 or 3G2 identified by the position identification information.

This allows the line of sight of the user who is at the image pickup position to be directed to a specific object that is desired to be viewed at the site.

The display control unit 170 or 530 changes the orientation of the virtual camera IC so that the display area includes predetermined coordinates or a low density portion in which the density with respect to the point cloud data with respect to the three-dimensional image 3G is lower than the threshold.

This allows the line of sight of the user located at the image pickup position to be directed to predetermined coordinates or to a specific object that corresponds to a low density portion in the three-dimensional image 3G.

The display control unit 170 or 530 displays on the display unit 20 or 520 a three-dimensional image 3G determined based on the output of the range information obtaining unit 13 located at the first position and the output of the range information obtaining unit 13 located at the second position different from the first position; and the display control unit 170 or 530 displays a display image on the display unit 20 or 520 including (i) the first position identification information 3G1 for identifying the first position and the second position identification information 3G2 for identifying the second position and (ii) the three-dimensional image 3G.

Thus, the positional relationships between the first and second image pickup positions and a specific object can be understood from the three-dimensional image 3G.

Although the information processing apparatuses and the information processing methods have been described with reference to the embodiments, the present invention is not limited to the embodiments, and various modifications and improvements can be made without departing from the scope of the claimed invention.

The present application is based on and claims priority to Japanese patent application No. 2021-048090, filed on Mar. 23, 2021, and Japanese patent application No. 2021-048245, filed on Mar. 23, 2021. The entire contents of Japanese patent application No. 2021-048090 and Japanese patent application No. 2021-048245 are hereby incorporated herein by reference.

### DESCRIPTION OF SYMBOLS

1 Image pickup apparatus (example of information processing apparatus)
3G Three-dimensional image
3Ga, 3Gb, 3Gc Identification information
3G1, 3G2 Position identification information
10 Housing
11 Image pickup unit
11a, 11A Image sensors
11b, 11B Fish-eye lenses
12 Projection unit
12a, 12A Light source units
12b, 12B Wide-angle lenses
13 Range information obtaining unit (example of light receiving unit)
13a, 13A TOF sensors
13b, 13B Wide-angle lenses
14 Processing circuit
15 Image pickup switch
20 Display unit
20A, 20a Display units
111 Other image pickup unit
150, 550, 650 Three-dimensional reconstruction processing units (examples of three-dimensional information determining unit)
160, 560, 660 Determining units
170 Display control unit (example of output unit)
180 Transmitting and receiving unit (example of output unit)
300 External apparatus (example of output destination)
500 Display apparatus (example of output destination and of information processing apparatus)
520 Display unit (example of output destination)
530 Display control unit (example of output unit)
600 Server
L Synchronization signal line

### CITATION LIST

### Patent Literature

[PTL 1] Japanese Unexamined Patent Application Publication No. 2018-077071
[PTL 2] Japanese Patent No. 5423287
[PTL 3] Japanese Patent No. 6192938

1. An information processing apparatus, comprising:
display control circuitry configured to display on a display a three-dimensional image that is determined based on an output of a light receiver that receives light projected on an object and reflected from the object,
wherein the display control circuitry is configured to display, on the display, a display image including position identification information identifying a position of the light receiver obtained when the light receiver receives light reflected from the object based on the position identification information identifying the position of the light receiver obtained when the light receiver receives the light reflected from the object, and including the three-dimensional image.

2. The information processing apparatus according to claim 1, wherein:
the display control circuitry is configured to display, on the display, based on area information indicating an area where a density with respect to point cloud data with respect to the three-dimensional image is lower than a threshold, the display image including low-density identification information identifying the area.

3. The information processing apparatus according to claim 1, wherein:
the display control circuitry is configured to display, on the display, the display image including second position identification information and the three-dimensional image, the second position identification information identifying a position of at least one of a distant object, a low reflective object, or a blind spot based on second position information indicating a position determined to correspond to, in the three-dimensional image, at least one of the distant object distant from the light receiver when the light receiver receives the light reflected from the object, the low reflective object having low reflectance with respect to projected light, or the blind spot with respect to the light receiver when the light receiver receives light reflected from the object.

4. The information processing apparatus according to claim 3, wherein:
the display control circuitry is configured to display the display image on the display based on the second position information indicating a position determined to have a density with respect to point cloud data with respect to the three-dimensional image lower than a threshold and determined to correspond to at least one of the distant object, the low reflective object, or the blind spot.

5. The information processing apparatus according to claim 3, wherein:
the display control circuitry is configured to display the display image on the display based on the second position information indicating a position determined to correspond to at least one of the distant object, the low reflective object, or the blind spot in the three-dimensional image based on the output of an image pickup unit that captures an image of the object.

6. The information processing apparatus according to claim 3, further comprising:
determining circuitry configured to determine a position corresponding to at least one of the distant object, the low reflective object, or the blind spot in the three-dimensional image,
wherein the display control circuitry is configured to display the display image on the display based on a determination result of the determining circuitry.

7. The information processing apparatus according to claim 1, wherein:
the display control circuitry is configured to change a display area of the three-dimensional image to be displayed on the display by changing a position and an orientation of a virtual camera that is at a point-of-view position from where the three-dimensional image is viewed.

8. The information processing apparatus according to claim 7, wherein:
the display control circuitry is configured to change the orientation of the virtual camera to a predetermined orientation when the position of the virtual camera is at a position identified by the position identification information.

9. The information processing apparatus according to claim 7, wherein:
the display control circuitry is configured to change the orientation of the virtual camera so that predetermined coordinates in the three-dimensional image are included in the display image.

10. The information processing apparatus according to claim 7, wherein:
the display control circuitry is configured to change the orientation of the virtual camera so that a low density portion having a density with respect to point cloud data with respect to the three-dimensional image lower than the threshold is included in the display image.

11. The information processing apparatus according to claim 1, wherein:
the display control circuitry is configured to display on the display a three-dimensional image determined based on an output of the light receiver located at a first position and an output of the light receiver located at a second position different from the first position, and display the display image on the display including first position identification information identifying the first position and second position identification information identifying the second position.

12. An information processing method, comprising:
identifying a position of a light receiver obtained when the light receiver receives light reflected from an object, based on position information indicating the position of the light receiver obtained when the light receiver receives the light reflected from the object,
displaying on a display a display image including position identification information based on the position identification information identifying the position identified in the identifying and including a three-dimensional image.

13. The information processing method according to claim 12, further comprising:
determining, based on an output of an image pickup unit configured to capture an image of the object, a position in the three-dimensional image, the position in the three-dimensional image being of at least one of a distant object that is distant from the light receiver when the light receiver receives light reflected from the object, a low reflective object with respect to the light being projected, or a blind spot with respect to the light receiver when the light receiver receives light reflected from the object,
wherein the displaying includes displaying on the display the display image including second position information indicating a position corresponding to at least one of the distant object, the low reflective object, or the blind spot, based on the second position information indicating the position determined in the determining.
